(19) United States
(12) Patent Application Publication
(10) Pub. No.: US 2016/0056759 A1
(43) Pub. Date: Feb. 25, 2016

(54) PHOTOVOLTAIC ENERGY SOURCES

(71) Applicant: Spinlectrix, Inc., Burlingame, CA (US)

(72) Inventors: John Michael Pinneo, Portola Valley, CA (US); Jonathan Forrest Garber, Hillsborough, CA (US); Frank H. Levinson, Tiburon, CA (US); Gerald Sage, Chico, CA (US)

(21) Appl. No.: 14/832,477

(22) Filed: Aug. 21, 2015

Related U.S. Application Data
(60) Provisional application No. 62/040,180, filed on Aug. 21, 2014.

(51) Int. Cl. H02S 40/38; H02J 5/00; H02S 40/34; G01R 31/40; H02S 30/10; H02S 40/32

(52) U.S. Cl. CPC H02S 40/38; H02S 30/10; H02S 40/32; H02S 40/34; H02S 50/00; H02J 5/00

(57) ABSTRACT

A photovoltaic (PV) panel includes a PV output, a storage and retrieval subsystem (storage subsystem), and PV cells. The PV output is configured to be coupled to a distribution system to supply electricity produced by the PV panel to the distribution system. The storage subsystem includes a dedicated storage device. The storage subsystem is electrically coupled to the PV output and provides per-panel energy storage. The PV cells are coupled to the PV output and to the storage device. The PV cells are configured to photovoltaically generate an electrical potential when exposed to incident illumination. While incident illumination is available, the PV cells supply a portion of the electrical potential to the PV output and a second portion to the dedicated energy storage device. The storage subsystem is configured to intermediately supply energy stored thereon to the PV output while the incident illumination is unavailable or partially unavailable.

### RELATED APPLICATIONS

This application claims the benefit of and priority to U.S. Provisional Application No. 62/040,180 filed Aug. 21, 2014, which is incorporated herein by reference in its entirety.

### FIELD

Embodiments described herein relate to photovoltaic energy sources.

### BACKGROUND

Electrical output of a photovoltaic (PV) panel may vary due to transient obstructions, such as clouds and dust storms. The obstructions are temporarily positioned between the sun and the PV panel, which may reduce electrical generation and accordingly electrical output of the PV panel. Alternatively, obstructions may include a characteristic that increases the electrical output. For instance, bright white clouds may reflect some radiation in addition to that illumination provided by the sun, which may increase the electrical output. The obstructions may be difficult to predict and may result in inconsistent and unreliable electrical output from the PV panel. The inconsistency of the electrical output contributes to an inability of an electrical grid to sufficiently rely on the PV panel.

In general, electrical grids can accommodate some inconsistency in electrical generation and variations in electrical loading. This inconsistency in electrical generation and these variations in electrical loading are usually slow and can be predictable. For example, a very hot day may be predicted. The very hot day may have associated with it a high electrical load, which can be accommodated for in energy markets. Similarly, a particular utility plant may have a scheduled maintenance period, which may result in lowered energy supply. Again, the scheduled maintenance period can be accommodated for in energy markets. For example, the scheduled maintenance and/or the high electrical load may be accommodated for by bringing another plant online, operating at a higher production rate, or purchasing electricity from another source. However, the output of the PV panel, because of transient obstructions, may vary quickly and unpredictably. Thus, the electrical grid cannot accommodate for such output variations of PV panels.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes a solar photovoltaic (PV) panel. The PV panel may be configured as a modular electrical source. The PV panel may include an electrical PV output, a storage and retrieval subsystem, and one or more PV cells. The electrical PV output is configured to be electrically coupled to a distribution system such that electricity produced by the PV panel is supplied to the distribution system. The storage and retrieval subsystem includes a dedicated energy storage device. The storage and retrieval subsystem is electrically coupled to the PV output and configured to provide per-panel energy storage to the PV panel. The PV cells are electrically coupled to the PV output and electrically coupled to the dedicated energy storage device. The PV cells are configured to photovoltaically generate an electrical potential in response to exposure to incident illumination. During periods in which incident illumination is available to the PV cells, the PV cells supply a first portion of the electrical potential to the PV output and a second portion of the electrical potential to the dedicated energy storage device. The storage and retrieval subsystem is configured to intermediately supply energy stored thereon to the PV output during periods in which incident illumination is partially unavailable or unavailable to the PV cells.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A is a block diagram of a photovoltaic (PV) panel;

FIG. 1B is a block diagram of the PV panel of FIG. 1A subject to an example transient obstruction;

FIG. 2 is an example plot depicting output of the PV panel of FIGS. 1A and 1B;

FIG. 3 is a plot depicting an example irradiance of an example PV panel during an example day;

FIG. 4A is a block diagram of an example PV panel;

FIG. 4B is a block diagram of the PV panel of FIG. 4A subject to an example transient obstruction;

FIG. 5 is an example plot depicting output of the PV panel of FIGS. 4A and 4B;

FIG. 6 illustrates an example PV assembly that includes an embodiment of the PV panel of FIGS. 4A and 4B;

FIG. 7 illustrates an example embodiment of a storage subsystem that may be implemented in the PV panel of FIGS. 4A and 4B;

FIG. 8 illustrates another example embodiment of a storage subsystem that may be implemented in the PV panel of FIGS. 4A and 4B;

FIG. 9 illustrates an example embodiment of a storage device that may be implemented in the PV panel of FIGS. 4A and 4B;

FIG. 10 illustrates another example embodiment of a storage device that may be implemented in the PV panel of FIGS. 4A and 4B;

FIG. 11A illustrates another example embodiment of a storage device that may be implemented in the PV panel of FIGS. 4A and 4B;

FIG. 11B illustrates another view of the storage device of FIG. 11A;

FIG. 11C illustrates another view of the storage device of FIGS. 11A and 11B; and

FIG. 12 illustrates a levitator assembly that may be implemented the storage device of FIGS. 11A and 11B,

all according to at least one embodiment described herein.

### DETAILED DESCRIPTION OF SOME EMBODIMENTS

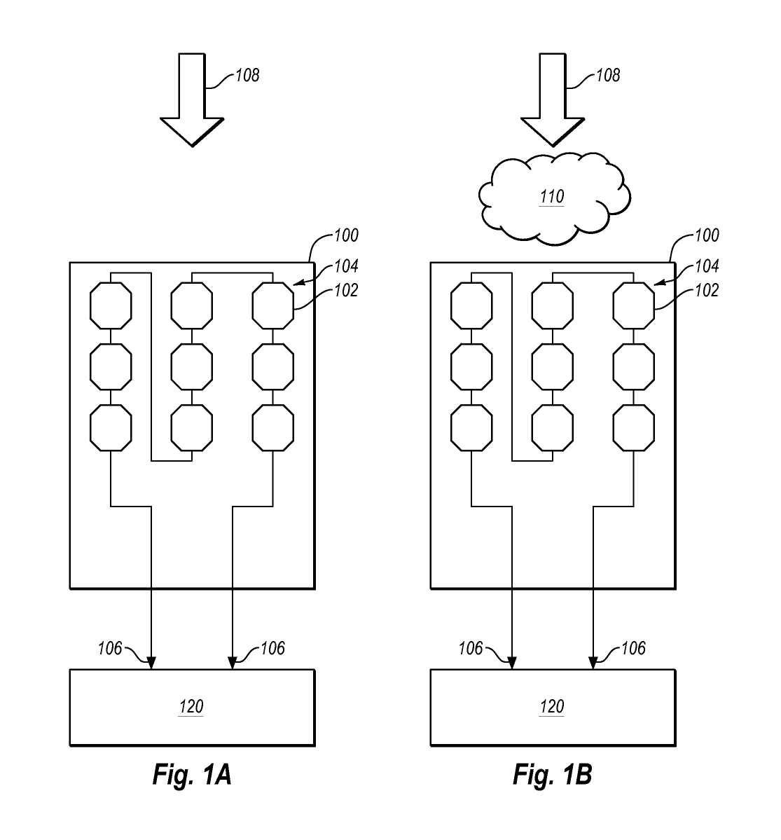

FIGS. 1A and 1B illustrate a solar photovoltaic (PV) panel 100. The PV panel 100 includes an interconnected PV device string 102 that includes multiple individual PV cells 104 that are electrically connected to a PV panel electrical output (PV output) 106. The PV cells 104 are configured to photovoltaically generate an electric potential in response to exposure to incident illumination. The incident illumination can be a result of insolation, which is represented in FIGS. 1A and 1B by an arrow and labeled 108. The PV output 106 may be electrically coupled to an electrical distribution system 120. Electricity produced by the PV panel 100 is supplied to the electrical distribution system 120. For instance, the PV panel 100 may be incorporated in a residential electrical distribution system such as a home, which may be an example of the distribution system 120. Additionally, the PV panel 100 may be incorporated in a public grid, which may be another example of the distribution system 120. The PV panel 100 of FIGS. 1A and 1B does not include or incorporate a dedicated energy storage device.

The PV panel 100 of FIG. 1A is subject to the insolation 108 without a transient obstruction. The insolation 108 without the transient obstruction is referred to as nominal insolation. Exposure of the PV panel 100 to the nominal insolation 108 of FIG. 1A results in delivery of a nominal electrical output at the PV output 106. In general, the nominal electrical output is delivered to the PV output 106 while nominal insolation 108 is available to the PV panel 100. In some embodiments, the nominal electrical output of the PV panel 100 includes an unregulated direct current (DC) voltage and DC current, regulated counterparts of the unregulated DC voltage and DC current, or an alternating current (AC) of a particular voltage, a particular frequency, and particular reactive power content. The nominal electrical output or some characteristic thereof may be controllable. For instance, the particular voltage, the particular frequency, the particular reactive power content, or some combination thereof may be controllable. Additionally or alternatively, in some embodiments, the nominal electrical output or some characteristic thereof may be predefined.

FIG. 1B illustrates the PV panel 100 subjected to insolation 108 that is obscured by a transient obstruction 110 represented by a cloud. The transient obstruction 110 is positioned between the PV panel 100 or a portion thereof and the insolation 108. The transient obstruction 110 interrupts availability of the insolation 108 or at least reduces availability of the insolation 108. Interruption in the insolation 108 results in a reduction in the electrical output delivered to the PV output 106. FIG. 1B depicts the transient obstruction 110 as a cloud. However, the insolation 108 may be obscured by multiple types of transient obstructions 110. Some other examples of transient obstructions 110 may include water, rain, snow, dust, shadows from airplanes or wind turbines, dust storms, plants or portions thereof (e.g., leaves falling on the PV panel 100), animals (e.g., swarms of insects), other environmental conditions, and the like.

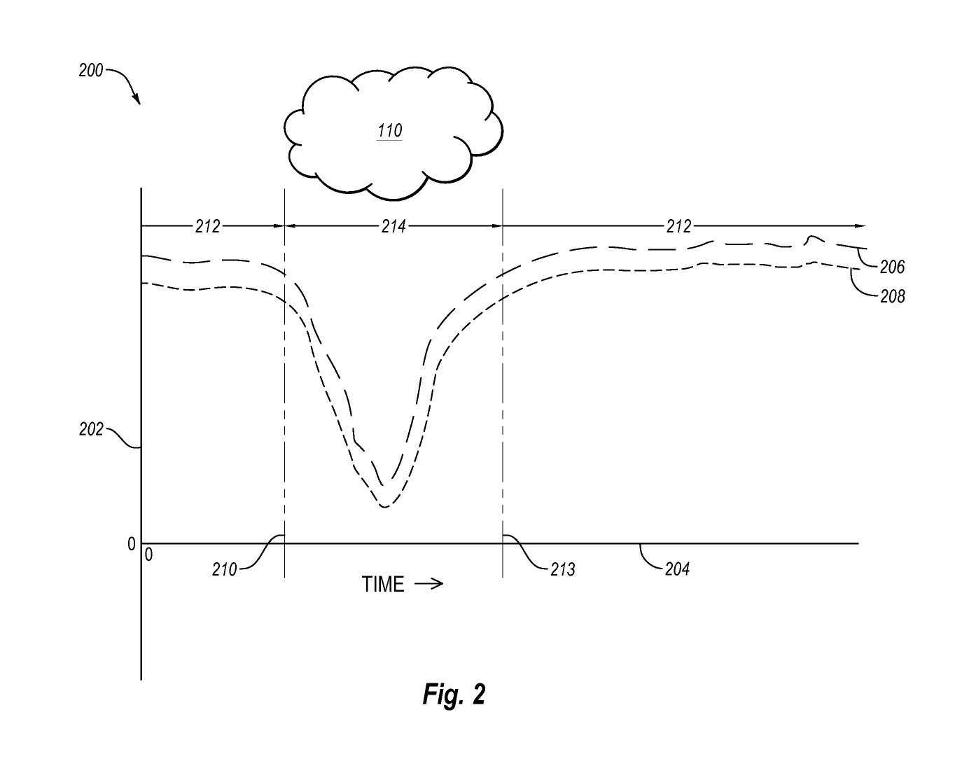

In general, the electrical output of the PV panel 100 is reduced for a period of time while the transient obstruction 110 is positioned between the insolation 108 and the PV panel 100 or a portion thereof. FIG. 2 illustrates a plot 200 that depicts an example variation in electrical output of the PV panel 100 because of the transient obstruction 110.

In the plot 200 of FIG. 2, insolation energy flux per unit area is plotted along a vertical axis 202. Time is plotted along the horizontal axis 204 of the plot 200. The insolation energy flux per unit area, which may be in W/m² and electrical output of the PV panel 100 are linearly related. Accordingly, the vertical axis 202 serves to illustrate the relationship between both the electrical output and the insolation energy flux per unit area during the depicted events. Additionally, the plot 200 includes an insolation line 206 and an electrical output line 208. With combined reference to FIGS. 1A-2, the insolation line 206 represents the insolation 108 to which the PV panel 100 is exposed. The electrical output line 208 represents the electrical output of the PV panel 100. The plot 200 includes a first period 212 and a second period 214. The first period 212 is during availability of the insolation 108 and the second period 214 is during unavailability or partial unavailability of the insolation 108.

The first period 212 exists from a time equal to 0 on the plot 200 to a first time 210 and from a second time 213 onward. During the first period 212 the electrical output of the PV panel 100 may be the nominal designed electrical output of the PV panel 100. At the first time 210, the transient obstruction 110 begins to obscure the insolation 108. The transient obstruction 110 may make the insolation 108 unavailable or partially unavailable. The second period 214 may include times from the first time 210 to a second time 213. The second time 213 corresponds to a time at which the transient obstruction 110 is no longer positioned between the insolation 108 and the PV panel 100. During the second period 214, the insolation line 206 and the electrical output line 208 begin to drop, representing a reduction from nominal insolation 108 and a corresponding reduction in electrical output of the PV panel 100. The electrical output and the nominal insolation 108 of the PV panel 100 may continue to be reduced during the second period 214. During the second period 214, the transient obstruction 110 may begin to move away from the PV panel 100, which may increase the insolation 108 and electrical output of the PV panel 100.

At the second time 213, the transient obstruction 110 is no longer positioned between the PV panel 100 and the insolation 108. Accordingly, the insolation 108 may increase and the electrical output of the PV panel 100 may also increase. The first period 212 may last from the second time 213 until another transient obstruction 110 is positioned between the PV panel 100 and the insolation 108.

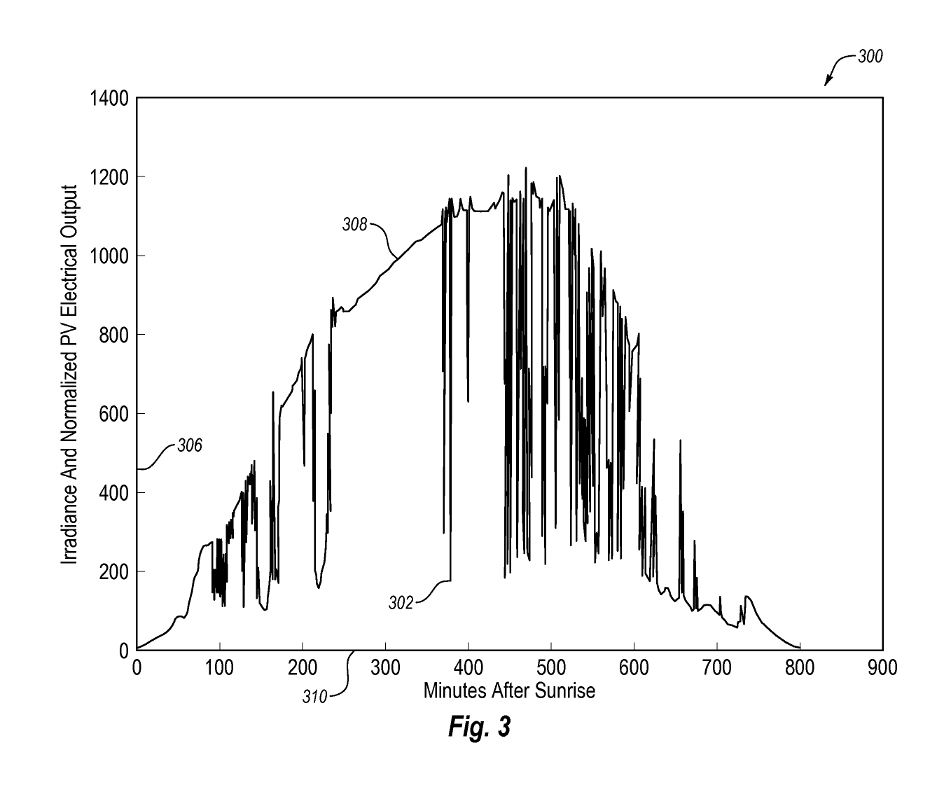

The plot 200 of FIG. 2 represents an example of changes to the electrical output and the insolation 108 because of a single, transient obstruction 110. FIG. 3 illustrates a plot 300 that represents an electrical output of a PV panel (e.g., the PV panel 100) over the course of a day. In FIG. 3, irradiance, also referred to as insolation in Watts per unit area as well as normalized electrical output of a PV panel is plotted along a vertical axis 306. Time is plotted along the horizontal axis 310. The plot 300 includes an electrical output line 308 with multiple transient insolation reductions 302. In the plot 300, the electrical output represented by the electrical output line 308 has been normalized to the same scale as an irradiance trace. Because the irradiance trace and the electrical output co-vary, the electrical output line 308 also represents the irradiance trace and appears as a single line (e.g., 308).

From FIG. 3, it can be seen that each of the transient insolation reductions 302 may last for a brief period of time (e.g., about five-fifteen minutes). Accordingly, the electrical output of the PV panel may fluctuate significantly (e.g., up to 100%) in a short period of time (e.g., about thirty seconds) and remain at this reduced output for a brief period of time. These fluctuations occur multiple times during the course of the day. In general, this fluctuation of electrical output introduces instability into systems (e.g., a power grid) incorporating the PV panel.

Accordingly, some embodiments described in this disclosure include a solar PV panel that is configured as a modular electrical source. The PV panel includes a PV output, a dedicated energy storage device, and one or more PV cells. The PV output is configured to be electrically coupled to an electrical distribution system and to supply electricity to the electrical distribution system. The dedicated energy storage device is electrically coupled to the PV output. The PV cells are electrically coupled to the PV output and electrically coupled to the dedicated energy storage device. The PV cells are configured to photovoltaically generate an electric potential in response to exposure to incident illumination during periods in which incident illumination is available to the photovoltaic cells and to supply a first portion of the electrical potential to the electrical output and a second portion of the electrical potential to the dedicated energy storage device. The dedicated energy storage device is configured to intermediately supply energy stored thereon to the PV output during periods in which incident illumination is unavailable or partially unavailable to the PV cells.

In some embodiments, the dedicated energy storage device includes a flywheel assembly. The flywheel assembly may further include rolling element bearings, passive magnetic bearings, an active magnetic rotor with position control, or some combination thereof. In some embodiments, the dedicated energy storage device may include an electrochemical storage device (e.g., a battery) or a pneumatic storage system. Additionally, in some embodiments, the dedicated energy storage device may include some combination of the flywheel, the electrochemical battery, and the pneumatic storage system.

Although FIGS. 2 and 3 depict reductions in the electrical output, in some circumstances, presence of the transient obstruction 110 may increase the electrical output of the PV panel above a nominal electrical output. The dedicated energy storage device of the PV panel may be configured to store the excess electrical output of the PV panel. For example, nominal electrical output of the PV panel may include about 111 Watts, about 69.4 Volts, and about 1.6 Amperes. Under conditions of the transient obstruction 110, the electrical output of the PV panel may increase to about 124 Watts, about 73 Volts, and about 1.7 Amperes. The dedicated energy storage device may be configured to store the additional 13 Watts, 3.6 Volts, and 0.1 Amperes, for the duration of the transient increase.

In addition, the energy storage device may be configured to store energy from the distribution system. Thus, the energy storage device may provide load-following to the distribution system, which may increase stability of the distribution system.

Some additional details of this and other embodiments are discussed with reference to the appended figures. In the appended figures, like numbers correspond to like structures unless described otherwise.

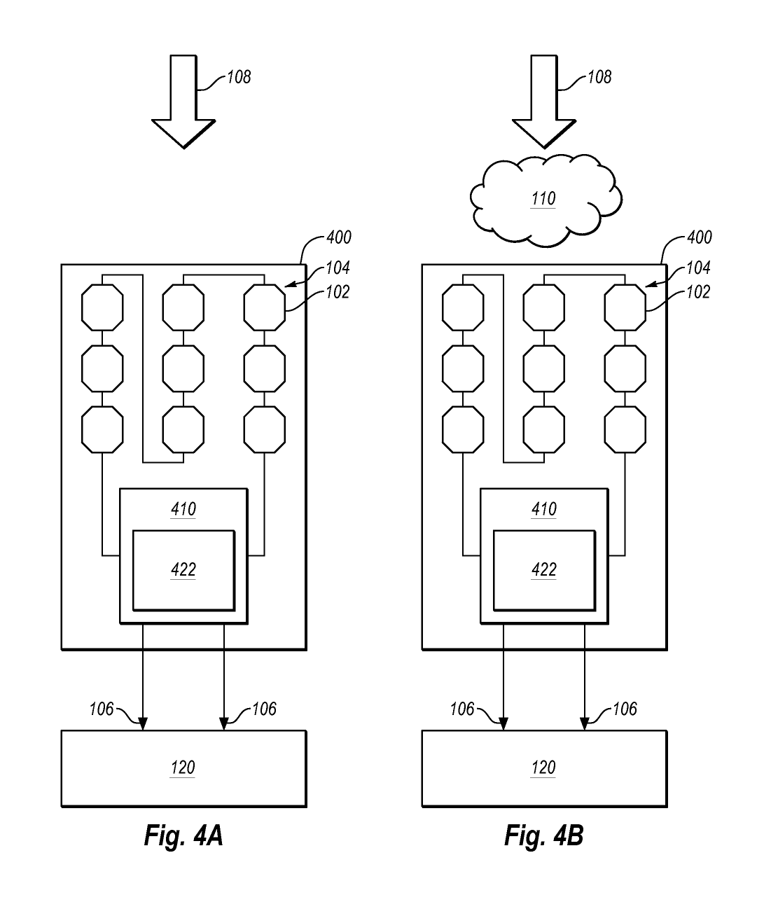

FIGS. 4A and 4B illustrate a solar PV panel 400. The PV panel 400 is similar to the PV panel 100. The PV panel 400 combines a storage and retrieval subsystem (storage subsystem) 410 with PV energy production components (e.g., the interconnected PV device string 102 and the PV cells 104). The storage subsystem 410 is configured to mitigate or eliminate electrical output instability of the PV panel 400. For example, the storage subsystem 410 is configured as dedicated energy storage of the PV panel 400.

The PV panel 400 thus stores a portion of the energy produced while the insolation 108 is available. In addition, the PV panel 400 may also store energy during periods of high production in the distribution system 120 and/or during period of higher than nominal electrical output of the PV panel 400. The storage subsystem 410 is further configured to retrieve the stored energy and make the stored energy available to the PV panel 400. For example, in response to unavailability or partial unavailability of the insolation 108 or when called upon by an external communication, the storage subsystem 410 may retrieve stored energy. The energy made available by the storage subsystem 410 may be adequate to maintain the nominal electrical output of the PV panel 400 despite some variations in the insolation 108.

The storage subsystem 410 may be characterized by a holdup time. The holdup time may indicate a particular duration in which the storage subsystem 410 provides the nominal electrical output of the PV panel 400 when the insolation 108 is completely unavailable. For instance, the PV panel 400 may include a nominal electrical output 110 Watts and the storage subsystem 410 may include a holdup time may be about 15 minutes. The holdup time indicates the storage subsystem 410 can maintain the nominal electrical output 110 Watts of the PV panel 110 for 15 minutes in the absence of insolation 108.

The holdup time is determined by the size and capacity of the storage subsystem 410. In some implementations, the holdup time may be about 10 minutes. In other implementations, the holdup time may be between about three hours and about five hours, for example. In embodiments in which the holdup time is between about three hours and about five hours, the storage subsystem 410 may provide some percentage of (e.g., 85%) of the nominal electrical output of the PV panel 400 for this period, which may enable some flexibility in the PV panel 400 and the storage subsystem 410 for variations due to transient obstructions 110 during this period.

In addition, the storage subsystem 410 may be configured to store and provide more than the nominal electrical output. Some embodiments of the storage subsystem 410 may provide between about 105% and about 300% of the nominal electrical output of the PV panel 400. For example, the PV panel 400 may include a nominal electrical output 110 Watts. The storage subsystem 410 may provide an electrical output of between about 115 and about 330 Watts. The electrical output of 330 Watts may be used in distribution grid stabilization. For instance, to make up for failures or reductions in production capacities in the distribution system 120.

The storage subsystem 410 provides per-panel energy storage. As used in this disclosure, “per-panel” indicates that the storage subsystem 410 is affiliated with the PV panel 400 and is not affiliated with other PV panels that may be included in a panel array that includes the PV panel 400. For instance, the storage subsystem 410 receives electricity produced by the PV cells 104 of the PV panel 400 and the storage subsystem 410 supplies energy stored thereon to the PV output 106 of the PV panel 400.

Moreover, “per-panel” may indicate control of the electrical output and input (e.g., in load-following applications) on a per-panel basis. For example, instead of a global or centralized control of an array that includes one or more of the PV panels 400, the storage subsystem 410 includes functionality that is dedicated to the control of the electrical output and input of the PV panel 400.

Generally, provision of per-panel energy storage enables distribution of energy storage in a panel array. The distribution of the energy storage enables efficient, rapid, and controllable response to the transient obstructions 110. The response to the transient obstructions 110 may smooth variability in the distribution system 120. For example, an operator of the distribution system 120 may control a ramp rate of the storage device 422 (e.g., the percent of nameplate or nameplate capacity/minute). The ramp rate may be controlled on a per-panel basis.

A panel array that includes a number of the PV panels 100 of FIGS. 1A and 1B without the storage subsystem 410 may require centralized energy storage system. The centralized energy storage system may store energy generated by multiple PV panels 100. The centralized energy storage system may be a large-scale, independent system (e.g., a hydraulic pump water storage or molten salt energy storage). When the electrical output of the panel array is reduced, the centralized energy storage system supplies energy to compensate for the reduction. However, the centralized energy storage system is large and complex and may not be able to mitigate electricity production reductions within the short periods (e.g., about 10 minutes) in which the insolation 108 is unavailable or partially unavailable.

In contrast, panel arrays with the PV panels 400 that use the per-panel storage may accommodate for the transient obstructions 110. The per-panel storage enables rapid mitigation of electricity production reductions on a per-PV panel 400 basis. Moreover, the individual PV panels 400 that are affected by the transient obstructions 110 individually make up for any reductions in local electricity production. In addition, inclusion of the storage device 422 may reduce cooling costs when compared to centralized energy storage systems and may eliminate a threat of a single point of failure.

In some embodiments, the storage subsystem 410 is an on-panel storage subsystem. As used in this disclosure, “on-panel” indicates that the storage subsystem 410 is physically connected or physically incorporated in the PV panel 400. For instance, the storage subsystem 410 may be welded or fastened to a frame of the PV panel. In other embodiments, the storage subsystem may not be on-panel but may still provide per-panel energy storage.

The storage subsystem 410 is sized such that the nominal output can be maintained for a particular duration. The particular duration is either greater than a period of unavailability or partial unavailability of the insolation 108 and/or greater than a period involved in the initiation of another mitigation measure. The storage subsystem 410 thus reduces disturbances to operation of the distribution system 120 to which the PV panel 400 provides electricity. In some embodiments, the particular duration may be about 10 minutes. Some additional details of the particular duration are discussed elsewhere herein.

In the embodiment of FIGS. 4A and 4B, the PV panel 400 includes the interconnected PV device string 102 that includes the PV cells 104. The interconnected PV device string 102 is electrically connected to the PV output 106. The PV cells 104 are configured to photovoltaically generate an electric potential in response to exposure to incident illumination. The incident illumination is represented in FIGS. 4A and 4B by the insolation 108. A source of the insolation 108 is, in some embodiments, the sun.

The PV output 106 may be electrically coupled to the distribution system 120. The PV panel 400 may supply some portion of the electricity produced by the PV cells 104 to the distribution system 120 via the PV output 106. For example, during periods in which the insolation 108 is available, a nominal output of the PV panel 400, produced by the PV cells 104 may be supplied to the distribution system 120. In addition, during periods in which the insolation 108 is available, some portion of the energy produced by the PV cells 104 may be provided to the storage subsystem 410 and stored therein.

The storage subsystem 410 may be electrically coupled to the interconnected PV device string 102. For example, in the depicted embodiment, the storage subsystem 410 is electrically coupled in parallel to the PV output 106. The storage subsystem 410 is configured to receive some portion of the electricity produced by the PV cells 104 while the insolation 108 is available and store the electricity. In some embodiments, the storage subsystem 410 may not store the electricity as electrical potential. For instance, the storage subsystem 410 may include a dedicated energy storage device (storage device) 422. The storage device 422 may include any system or device that is capable of storage of energy and retrieval of the stored energy to PV panel 400.

An example of the storage device 422 is a flywheel. Rotation of the flywheel may be imposed due to electricity produced by the PV cells 104. The rotation stores the electricity produced by the PV cells 104 as kinetic energy. Another example of the storage device 422 is an electrochemical battery. The electrochemical battery may be charged by the electricity produced by the PV cells 104. Another example of the storage device 422 may include a compressed gas system. The compressed gas system may use the electricity produced by the PV cells 104 to impose a pressure on a gas. The pressure stores the electricity produced by the PV cells 104 as pneumatic potential energy.

In addition, the storage subsystem 410 is configured to supply stored energy in the form of electricity to the electrical distribution system 120 via the PV output 106. For example, the PV storage subsystem 410 may supply electricity to the distribution system 120 while the insolation 108 is unavailable or partially unavailable. For instance, FIG. 4B depicts the transient obstruction 110 obscuring the insolation 108.

The amount of electricity supplied to the distribution system 120 may be related to the effect on the PV panel 400 of the unavailability or partial unavailability of the insolation 108. For example, the storage subsystem 410 may supply electricity to the distribution system 120 such that the nominal electrical output of the PV panel 400 is constant or substantially constant. During periods in which the storage subsystem 410 is supplying electricity to the distribution system 120, the constant or substantially constant nominal electrical output of the PV panel 400 may include a first portion that results from electrical production of the PV cells 104 and a second portion that is supplied from the storage subsystem 410. Additionally, in some circumstances, the storage subsystem 410 may supply all of the nominal electrical output of the PV panel 400.

In some embodiments, the storage subsystem 410 may supply electricity to the distribution system 120 outside of periods of unavailability or partial unavailability of the insolation 108. For example, during peak loads of the distribution system 120, the storage subsystem 410 may supply electricity to the distribution system 120. Additionally or alternatively, the storage subsystem 410 may supply electricity to the distribution system 120 in response to an equipment failure or any other circumstance in which additional electrical output may be beneficial.

An example of the PV panel 400 may include a nominal maximum DC output power of 110 Watts at a nominal output voltage of 69.4 Volts and a nominal output current of 1.59 Amperes. In addition, in FIGS. 4A and 4B, only one PV panel 400 is depicted. However, the PV panel 400 may be incorporated into a panel array that includes multiple PV panels 400. The panel array may include thousands of the PV panel 400 as part of a large solar photovoltaic generation facility.

Embodiments depicted in FIGS. 4A and 4B depict per-panel implementations in which the PV panel 400 includes the storage device 422. In some embodiments, the storage device 422 and the storage subsystem 410 may be associated with a small number of PV panels 400. For example, the storage device 422 and the storage subsystem 410 may be associated with between two and ten PV panels 400. Generally, the PV panels 400 associated with the storage device 422 and the storage subsystem 410 may be located physically close to one another in a panel array.

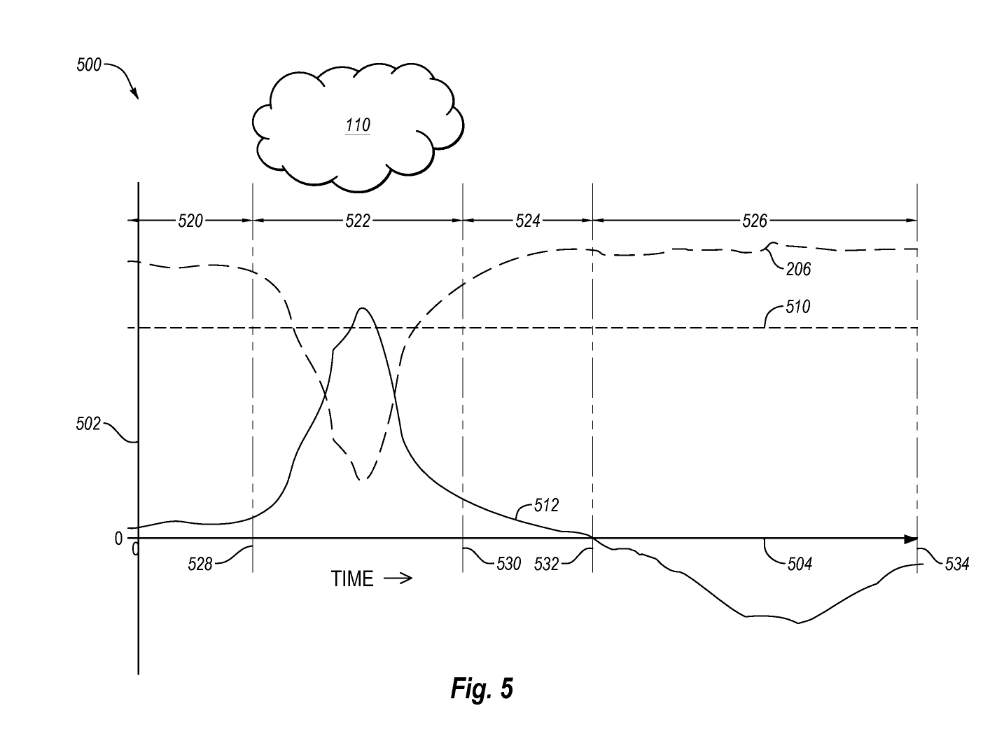

FIG. 5 is an example plot 500 that depicts electrical output of the PV panel 400 of FIGS. 4A and 4B. With combined reference to FIGS. 4A-5, in FIG. 5, insolation energy flux per unit area is plotted along a vertical axis 502. Time is plotted along a horizontal axis 504. The insolation energy flux per unit area, which may be in W/m² and electrical output of the PV panel 400 are linearly related. Accordingly, the vertical axis 202 serves to illustrate the relationship between both the electrical output and the insolation energy flux per unit area during the depicted events. The plot 500 includes the insolation line 206 discussed with reference to FIG. 2. The plot 500 also includes an electrical output line 510 and a storage subsystem output line 512. The electrical output line 510 represents the net electrical output of the PV panel 400. The storage subsystem output line 512 represents energy output of the storage subsystem 410.

The plot 500 may be separated into four time periods 520, 522, 524, and 526. A first time period 520 is from time equal to 0 on the plot 500 until a first time 528. The first time 528 represents an onset of insolation reduction.

The first time period 520 is representative of circumstances in which the insolation 108 is available and the storage device 422 of the storage subsystem 410 is substantially full or has reached a limit determined by a customer. During the first time period 520, the electrical output of the PV panel 400 is substantially constant. The electrical output is supplied by electricity produced by the PV cells 104 (of FIGS. 4A and 4B). There may be some output by the storage subsystem 410. The output by the storage subsystem 410 may be supplying components (e.g., providing power to a controller) of the storage subsystem 410, for instance.

A second time period 522 is from the first time 528 until a second time 530. The second time 530 represents cessation of the insolation reduction. During the second time period 522, the insolation 108 may be considered unavailable or partially unavailable. In some embodiments, the insolation 108 is considered unavailable or partially unavailable when the nominal electrical output of the PV panel 400 supplied by the PV cells 104 is decreased by more than about 10%. Similarly, the insolation 108 may be considered available so long as about 90% the nominal electrical output of the PV panel 400 is supplied by the PV cells 104.

During the second time period 522, the energy output of the storage subsystem 410 increases relative to a reduction in the insolation 108 such that the electrical output of the PV panel 400 is substantially constant.

A third time period 524 is from the second time 530 until a third time 532. The third time 532 represents a time in which electricity produced by the PV cells 104 is supplied to the storage subsystem 410. During the third time period 524, some amount of energy may be supplied by the storage subsystem 410. However, the electrical output of the PV panel 400 is supplied by the electricity produced by the PV cells 104.

A fourth time period 526 is from the third time 532 until a fourth time 534. The fourth time 534 represents a time in which the storage device 422 of the storage subsystem 410 is full. During the fourth time period 526, the electrical output of the PV panel 400 is supplied by electricity produced by the PV cells 104. In addition, electricity produced by the PV cells 104 is being stored in the storage subsystem 410. In the plot 500, the portion of storage subsystem output line 512 below the horizontal axis 504 represents charging or energy storage.

On the plot 500, the electrical output line 510 is substantially constant. In some embodiments, during the second time period 522, the electrical output line 510 may be somewhat lower. In these and other embodiments, the electrical output line 510 may be a step function beginning at the first time 528 and ending at the second time 530. For example, the electrical output line 510 may be constant during the first time period 520, the third time period 524, and the fourth time period 526. During the second time period 522, the electrical output line 510 may be about 80% of the value during the first time period 520, the third time period 524, and the fourth time period 526.

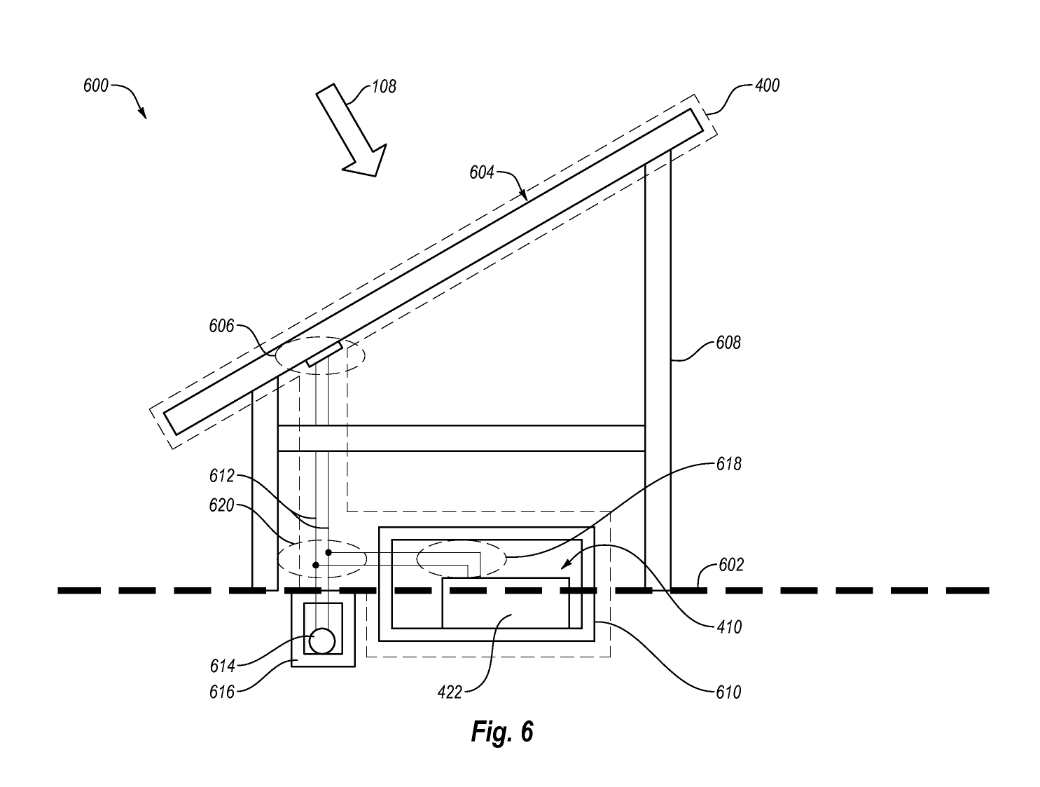

FIG. 6 illustrates an example PV assembly 600 that includes an embodiment of the PV panel 400. FIG. 6 depicts a sectional view of the PV assembly 600. The PV assembly 600 is depicted mounted on the ground 602 with the storage subsystem 410 mounted partially below a surface of the ground 602. The PV panel 400 may be mounted to a frame 608, which is positioned on the ground 602. The frame 608 supports the PV panel 400 above the ground 602 and may physically contain an enclosure 610. The storage subsystem 410 or some portion thereof is positioned in the enclosure 610. For example, in the embodiment of FIG. 6, the storage device 422 is positioned within the enclosure 610.

In FIG. 6, the enclosure 610 is partially below the ground 602. The enclosure 610 may be positioned below the ground 602 to reduce damage if the storage device 422 fails. For instance, the storage device 422 may include a flywheel that stores energy in inertia. The flywheel may rotate at a high rotation per minute (RPM). For example, the flywheel may rotate at about 70,000 to about 90,000 RPM. If there is a mechanical failure, the flywheel or components thereof may become disconnected and may damage other components of the PV assembly 600. By positioning the enclosure 610 at least partially below the ground 602, any damage caused by failure of the flywheel may be reduced.

The insolation 108 may impinge on a surface 604 of the PV panel 400. The insolation 108 may result in production of electricity that is communicated via a connection 606 to PV panel output connection cables 612. The PV panel output connection cables 612 connect to a series connection 614. The series connection 614 may be an example of the PV output 106 discussed above. The series connection 614 may electrically connect to another PV assembly and/or to a distribution system (e.g., the distribution system 120 discussed above). The series connection 614 may be positioned in a cable run enclosure 616.

In some embodiments, multiple (e.g., 1000) PV assemblies 600 are installed in series. The cable run enclosure 616 may be constructed below the multiple PV assemblies 600. A cable that connects the PV assemblies 600 may be positioned above the cable run enclosure 616. Each of the PV assemblies 600 may be connected to the cable at the series connection 614.

The PV panel output connection cables 612 connect to storage device connections 618 via panel/storage device connections 620. When the insolation 108 is available, a first portion of the electricity produced by PV cells 104 (not shown) in the PV panel 400 is supplied to the series connection 614. A second portion of the electricity produced by the PV cells 104 is supplied to the storage device 422 via the panel/storage device connections 620 and the storage device connections 618. In response to the insolation 108 being unavailable or partially unavailable, energy stored in the storage device 422 may be supplied to the series connection 614 via the storage device connections 618 and the panel/storage device connections 620.

As depicted in FIG. 6, the PV assembly 600 includes the storage device 422. The storage device 422 included in the PV assembly 600 is an example of on-panel storage. The storage device 422 is integrated in the PV assembly 600. In systems including multiple PV assemblies 600, each of the PV assemblies 600 may include the on-panel storage as depicted in FIG. 6. In other embodiments, the enclosure 610 in which the storage device 422 is positioned may be located away from the PV panel 400. In these and other embodiments, the storage device 422 may provide per-panel storage.

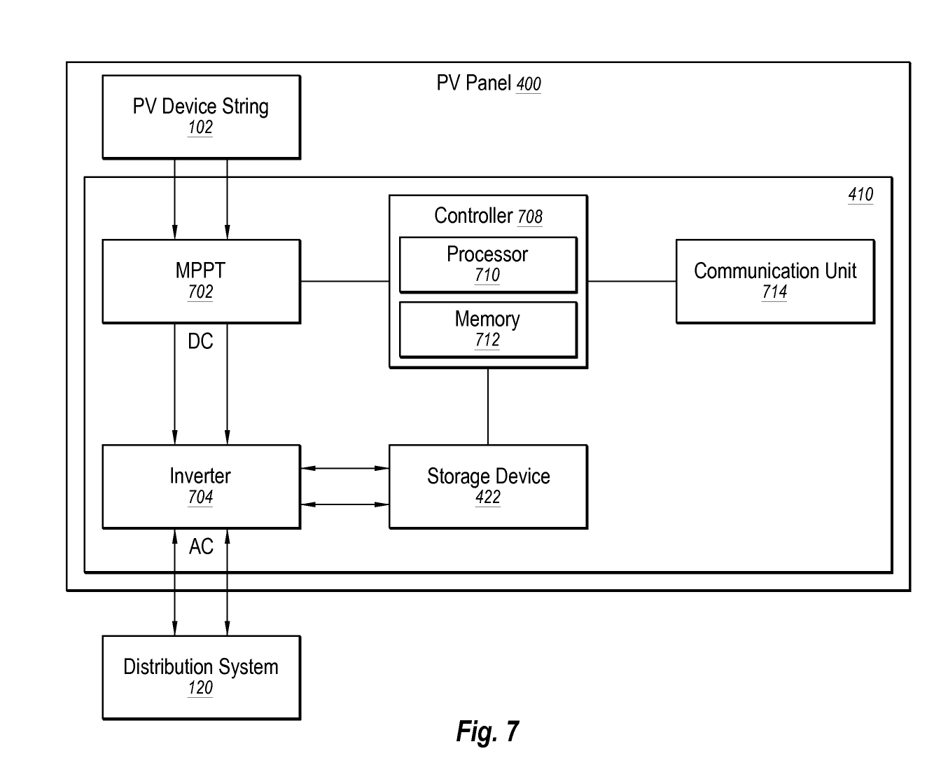

FIG. 7 illustrates an example embodiment of the storage subsystem 410. The storage subsystem 410 is depicted electrically coupled between the PV device string 102 of the PV panel 400 and the distribution system 120 discussed elsewhere in this disclosure. The storage subsystem 410 of FIG. 7 is an example of an on-panel storage subsystem. In addition to the functionality discussed elsewhere in this disclosure, the storage subsystem 410 provides per-panel energy storage management functionality.

For example, the storage subsystem 410 manages supply of the electricity produced by the PV device string 102 to the energy storage device 422. In addition, the storage subsystem 410 manages the energy retrieval from the storage device 422 and its supply to the distribution system 120. In some embodiments, the storage subsystem 410 may further manage energy provided by the distribution system 120 to the storage device 422.

The storage subsystem 410 of FIG. 7 may include the energy storage device 422, a maximum power point transfer (MPPT) device 702, an inverter 704, a controller 708, a communication unit 714, or some combination thereof. The controller 708 may enable a customer to define a particular behavior of the PV panel 400. The controller 708 may be programmed for allocation of energy between the storage device 422 and the distribution system 120. For example, a customer may set ramp rates, rates at which energy is absorbed by the storage device 422, an amount to which the storage device 422 is charged, define panel behavior based on environmental or grid load circumstances, set an electrical output of the PV panel 400 (e.g., a substantially constant electrical output), set an electrical output reduction rate (e.g., reduction of 1% per minute), or some combination thereof.

The controller 708 may also communicate signals to one or more of the communication unit 714, the MPPT 702, the inverter 704, the energy storage device 422, or some combination thereof. For example, the controller 708 may receive a signal indicative of a reduction in electricity output from the PV device string 102, and the controller 708 may then communicate a control signal that commands the inverter to pull energy from the storage device 422.

In the depicted embodiment, the controller 708 may include one or more processors 710 and memory 712. The processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an application-specific integrated circuit (ASIC), a field-programmable gate array (FPGA), or any other digital or analog circuitry configured to interpret and/or to execute program instructions and/or to process data.

Although illustrated as a single processor in FIG. 7, the processor 710 may more generally include any number of processors configured to perform individually or collectively any number of operations described in the present disclosure. Additionally, one or more of the processors 710 may be present on one or more different electronic devices or computing systems. In some embodiments, the processor 710 may interpret and/or execute program instructions and/or process data stored in the memory 712 or other data storage. In some embodiments, the processor 710 may fetch program instructions from the memory 712 and load the program instructions. After the program instructions are loaded, the processor 710 may execute the program instructions.

The memory 712 may include computer-readable storage media for carrying or having computer-executable instructions or data structures stored thereon. Such computer-readable storage media may include any available media that may be accessed by a general-purpose or special-purpose computer, such as the processor 710. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

In the embodiment depicted in FIG. 7, the storage subsystem 410 includes the controller 708. These and other embodiments may include a configuration that includes one controller (e.g., 708) per panel. In these and other embodiments, the controller 708 is dedicated to the PV panel in which it is implemented. Accordingly in an array including multiple PV panels having a one controller per panel configuration, there may not be a global controller that determines the output and input of individualized PV panels. A lack of a global controller may eliminate or reduce single-point failure vulnerabilities in the array.

The communication unit 714 may include one or more pieces of hardware configured to receive and send communications. In some embodiments, the communication unit 714 may include one or more of an antenna, a wired port, and modulation/demodulation hardware, among other communication hardware devices. In particular, the communication unit 714 may be configured to receive a communication from outside the PV panel 400 and to present the communication to the processor 710 or to send a communication from the processor 710 to another device or network.

In some embodiments, the communication unit 714 may be configured to communicate status signals pertaining to operations of the PV panel 400. For example, the communication unit 714 may be configured to input/output signals informing a grid manager of an operational status (e.g., state of the charge) of the PV panel 400. Additionally, new programs or changes to instructions may be communicated to the controller 708 via the communication unit 714.

In embodiments including the controller 708 and the communication unit 714, a program may be preset to the controller 708. Control communications may be received by the communication unit 714, which may modify or overwrite the preset program.

In some embodiments, the storage subsystem 410 may include the communication unit 714 but omit the controller 708. In these and other embodiments, the storage subsystem 410 may receive control communications that are directly communicated to one or more of the energy storage device 422, the MPPT device 702, and the inverter 704.

The MPPT device 702 may be electrically coupled to the PV device string 102, the controller 708, and the inverter 704. The MPPT device 702 may be configured to perform MPPT techniques. For example, the MPPT device 702 may be configured to determine an optimal current-voltage (IV) point. The IV point may change due to environmental conditions such as temperature, insolation, and the like.

The inverter 704 may receive a signal from the controller 708 and in response draw energy from the storage device 422. The inverter 704 may convert energy drawn from the storage device 422 and the PV device string 102 from direct current (DC) to alternating current (AC). The inverter 704 may then communicate the electricity converted to AC to the PV output 106.

The inverter 704 may be a bi-directional inverter. In embodiments in which the inverter 704 is bi-directional, electricity may be drawn from the distribution system 120. For example, in circumstances in which the energy production in the distribution system 120 exceeds a load in the distribution system 120, electricity may be drawn from the distribution system 120 and stored in the storage device 422. The electricity may be drawn from the distribution system 120. The electricity is then converted from AC to DC and supplied to the storage device 422.

For example, in some embodiments, the storage device 422 may be set to only charge or store about 50% to about 60% of a designed-for capacity. During periods in which energy generation on the grid is high (more than load), excess electricity is stored on the storage device 422. Storage of the excess electricity is referred to as “load following.”

In some embodiments, the storage subsystem 410 of FIG. 7 may include an energy dissipator such as a resistor. If adequate energy storage capacity is not available in the storage device 422 to store the entire amount of energy involved by load following corrective measures, then the storage subsystem 410 may dissipate excess energy through the dissipater.

Furthermore, the inverter 704 may controllably alter its AC output parameters, including voltage, current, frequency, phase, harmonic content, or any combination thereof. Such alterations may be in response to commands generated off-panel and received by communications unit 714, or in response to algorithms executed by the processor 710, or a combination thereof.

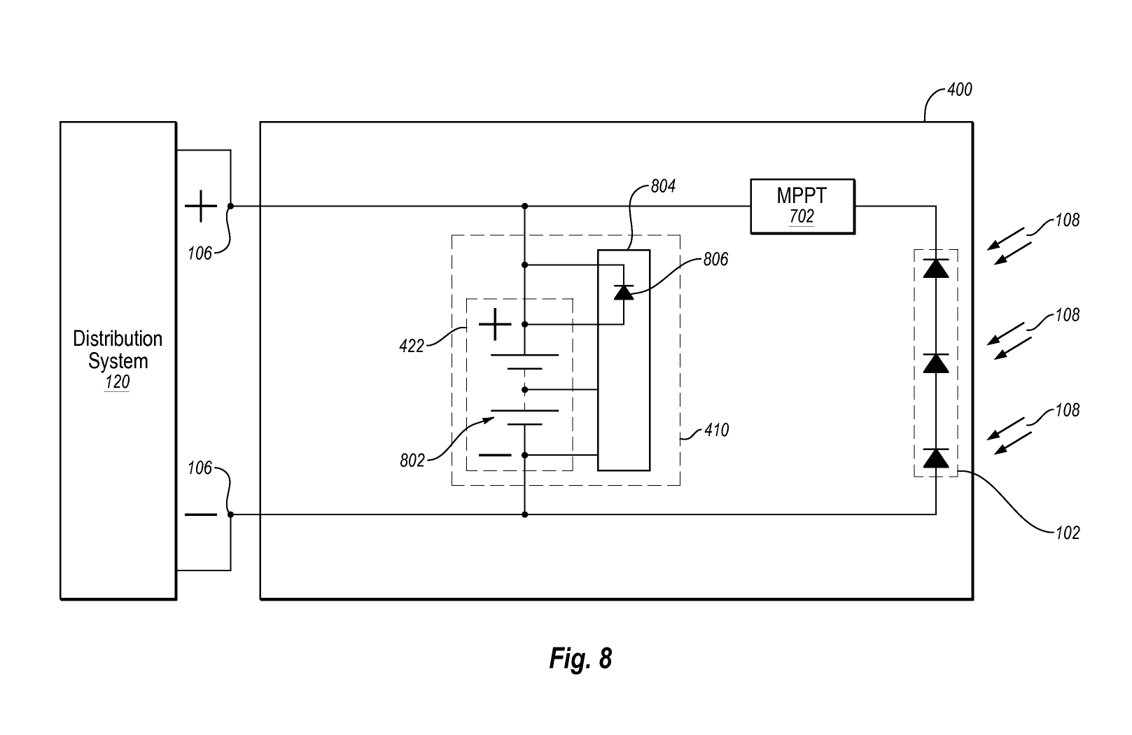

FIG. 8 depicts another example embodiment of the storage subsystem 410 that may be implemented in the PV panel 400. The embodiment of FIG. 8 includes a simple embodiment of per-panel energy storage implemented with the PV panel 400. The PV panel 400 includes a storage device 422 that includes a rechargeable electrochemical storage device (battery) 802. The battery 802 is electrically coupled to the PV device string 102. The battery 802 is configured to maintain and/or stabilize electrical output of the PV panel 400 as discussed elsewhere in this disclosure.

In the embodiment of FIG. 8, the storage subsystem 410 that provides per-panel storage to the PV panel 400 is on-panel. In other embodiments, the storage subsystem 410 may be off-panel. The battery 802 may include active or passive temperature control such as thermal insulation, temperature control by thermally driven phase change of materials, or temperature control by thermoelectric devices.

In the embodiment depicted in FIG. 8, the storage subsystem 410 incorporates battery management electronics 804 that operate the electrochemical cells of the battery 802 within safe limits. For example, the battery management electronics 804 may operate the electrochemical cells regarding aspects of charge, discharge, cell state of charge balance, depth of discharge, fault mitigation, and other parameters.

In the embodiment depicted in FIG. 8, when electrical energy produced by the PV device string 102 decreases below a voltage of the battery 802, the electrical output available at PV output 106 declines until it is approximately equal to the voltage exhibited by the battery 802. The voltage exhibited by the battery 802 may be determined by the state of charge, temperature, and voltage drops.

An isolation diode 806 may be incorporated within the storage subsystem 410 and its battery management electronics. Upon the electrical output at the PV output 106 being about equal to or less than the charge of the battery 802, the battery 802 begins to supply electrical energy to the PV output 106. The amount of electrical energy supplied to the PV output 106 may be related to a difference between electrical output and the charge of the battery 802. The battery 802 continues to supply electrical energy to the PV output 106 until insolation 108 is available and the electrical output of the PV panel 400 rises above the charge of the battery 802 or the battery 802 is fully discharged.

In some embodiments, a predetermined portion of electrical energy produced by the PV device string 102 may be used to recharge the battery 802 while continuing to supply energy to the PV output 106.

In contrast with the embodiment of FIG. 7, the embodiment of FIG. 8 is very simple. The embodiment of FIG. 8 may omit components for communications, computation, DC/AC conversion, or other electronic functionalities. Additionally, in some embodiments the MPPT 702 may be further omitted. Instead, the embodiment of FIG. 8 includes battery management electronics 804 and isolation diode 806 used to stabilize the electrical output of the PV panel 400.

In a non-depicted embodiment, the storage device 422 may include a flywheel assembly with its integral operational control electronics in close analogy to the embodiment of FIG. 8. Additionally, the storage device 422 may include multiple storage devices 422, each incorporating its particular storage management functionality. In some embodiments, the PV panel 400 may include the MPPT device 702. The MPPT device 702 operates to maintain the electrical output of the PV panel 400 at a maximum possible under operating conditions that determine the IV curve of the PV panel 400. The operating conditions may include temperature, insolation, and the particular technology employed for manufacture of the PV panel 400. The MPPT device 702 may employ algorithms such as perturb and observe algorithm, hill climbing algorithm, incremental conductance algorithm, current sweep algorithm, or constant voltage algorithm. The MPPT device 702 resides in a physical device dedicated solely to MPPT operations or may be integrated into other devices. The MPPT device 702 may be easily retrofitted to the PV panel 400.

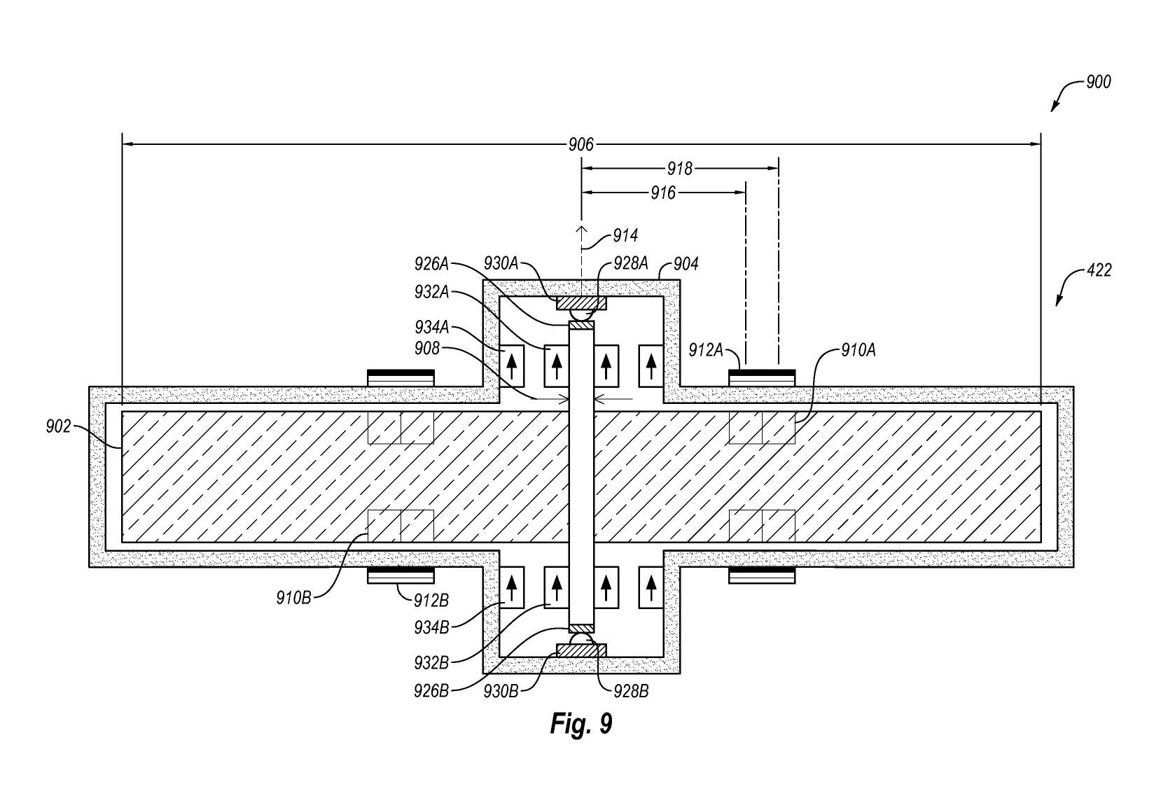

FIG. 9 illustrates an example embodiment of the storage device 422. In the embodiment of FIG. 9, the storage device 422 includes a flywheel assembly 900. The flywheel assembly 900 of FIG. 9 may be electrically coupled to a PV device string such as the PV device string 102 and to a PV output such as the PV output 106 described elsewhere in this disclosure. The flywheel assembly 900 is configured to maintain and/or stabilize electrical output of a PV panel including the flywheel assembly 900 as discussed elsewhere in this disclosure.

The flywheel assembly 900 may be configured with a larger energy storage range and larger energy retrieval range than battery 802 of FIG. 8. For example, the flywheel assembly 900 may provide electrical energy output that exceeds a nominal energy output of a PV panel or without damaging the flywheel assembly 900. When compared to the battery of 802 of FIG. 8, the flywheel assembly 900 may be configured with a larger energy storage rate, storage power and larger energy retrieval rate, retrieval power, or some combination thereof.

The flywheel assembly 900 may include a flywheel rotor 902 that is positioned within an evacuated enclosure 904. In some embodiments, the flywheel rotor 902 may be comprised of a carbon fiber matrix composite material. The carbon fiber may include any suitable material such as M30 product from Toray Carbon Fibers America, Inc. The carbon fiber matrix may be a polymeric form of dicyclopentadiene (DCPD) polymerized according to metathesis reactions, for instance. In other embodiments, the flywheel rotor 902 may be comprised of another material or another polymeric form.

In the embodiment of FIG. 9, the flywheel rotor 902 may have an outer diameter 906 of about 5 inches, an inner diameter 908 of about 10 millimeters, and a nominal thickness (in FIG. 9, extent in an arbitrarily defined z-direction) of about 1.0 inch. The flywheel rotor 902 may include about 1.25 pounds of carbon fiber M30. The carbon fiber M30 is circumferentially wrapped in the flywheel rotor 902 with a winding inclination or pitch of about 5° with respect to the planar end faces of the flywheel rotor 902.

Two circular arrays of magnets (magnet arrays) 910A and 910B are imbedded in the flywheel rotor 902. The arrays of magnets 910A and 910B may be disposed in the flywheel rotor 902 during the fabrication of the flywheel rotor 902. The arrays of magnets 910A and 910B rotate with the flywheel rotor 902 and project magnetic fields across the enclosure 904 to interact, respectively, with electromagnetic coil assemblies 912A and 912B. The magnet arrays 910A and 910B may include N42 grade rare earth magnets. One or more individual magnets of magnet arrays 910A and 910B may include a nickel-plated cube. The magnets may include an edge length of about 0.5 inches.

The magnet arrays 910A and 910B are distributed on a top face and a bottom face of flywheel rotor 902. Array centerline radii 916 and 918 may be at about 1.75 inches and about 2.35 inches from a central rotational axis 914 of flywheel rotor 902. The magnets of the magnet arrays 910A and 910B are angularly displaced from its adjacent neighbors by approximately 20 degrees. In the depicted embodiment, the magnet arrays 910A and 910B include eighteen magnets. The flywheel rotor 902 may include fifty-two magnets total. In other embodiments the magnet arrays 910A and 910B may include fewer than eighteen or more than eighteen magnets. Additionally, the magnet arrays 910A and 910B may be positioned at different centerline radii 916 and 918. Other embodiments may include other types or dispositions of magnets and other operative configurations such as an arrangement of magnet polarities in a Halbach configuration as well as magnets of other geometries, and other rare earth magnet grades.

The electromagnetic coil assemblies 912A and 912B may include multiple coils. For example, in an example embodiment, the electromagnetic coil assemblies 912A and 912B may include twelve coils with fifteen turns of #22 insulated copper magnet wire. Each of the coils includes an approximate major diameter of about 1.0 inch. The twelve coils are disposed in a circular pattern and fixed to an outside surface of the enclosure 904, with each of the coils being centered at a radius of about 2.0 inches from a radial center of the enclosure 904. The coils may be positioned on the enclosure 904 at regularly spaced angular positions separated by about 20 degrees around the enclosure 904.

To store energy within the flywheel assembly 900, the electromagnetic coil assemblies 912A and 912B are electrically connected to drive electronics (not depicted) that supply the electromagnetic coil assemblies 912A and 912B with electrical energy. Forces arise from the interaction of electromagnetic fields created by the electromagnetic coil assemblies 912A and 912B with permanent magnetic fields provided by the magnet arrays 910A and 910B. The forces cause the flywheel rotor 902 to increase a rotation rate, thereby effecting the conversion of electrical energy supplied to the electromagnetic coil assemblies 912A and 912B. Increasing the rotation rate increases rotational kinetic energy of the flywheel rotor 902.

To recover electrical energy from the flywheel assembly 900, induced current is driven by the relative motion of electromagnetic coil assemblies 912A and 912B to the magnetic fields from rotating magnet arrays 910A and 910B. The electromagnetic coil assemblies 912A and 912B to a PV output (e.g., the PV output 106) after being transformed and/or rectified according to whether panel output is required as AC or DC power. Rotational kinetic energy is thereby transformed to electrical energy in accordance with principles of electric generators.

The inner diameter 908 of flywheel rotor 902 is mechanically fixed to a shaft 920. The shaft 920 may include a diameter of about 0.500 inch and may be comprised of stainless steel. The flywheel rotor 902 is wound onto the shaft 920 so that in operation, the two components rotate together as an integrated assembly. The shaft 920 may be constructed from stainless steel alloy 316 or similar alloys having a relative magnetic permeability of less than about 100. The shaft 920 may be comprised of other materials having similar magnetic and mechanical properties. Examples of such shaft materials may include titanium, silicon carbide, and cermet compositions. Additionally, in some embodiments, rather than winding the flywheel rotor 902 material directly on the shaft 920. For example, an interface component (not depicted) may be installed between the flywheel rotor 902 and the shaft 920 to provide advantageous mechanical properties, such as enhanced compliance and/or energy dissipation (damping).

In the embodiment of FIG. 9, the flywheel rotor 902 and the shaft 920 comprise a rotating assembly. The rotating assembly is radially located by a first passive magnetic bearing and a second passive magnetic bearing. The first passive magnetic bearing includes mutually repulsive cylindrical magnet components (repulsive magnets) 934A and 932A. The second passive magnetic bearing includes repulsive magnets 934B and 932B. The repulsive magnets 932A, 932B, 934A, and 934B are axially magnetized. For example, the North and South poles are located on the parallel, planar magnet end faces and the magnetization axis is parallel to the cylindrical axis 914. In FIG. 9, each of the repulsive magnets 932A, 932B, 934A, and 934B include arrows indicating an orientation of the North and South poles.

The repulsive magnets 932A, 932B, 934A, and 934B are oriented so that the radial interaction is repulsive. In addition, radial equilibrium positions occur when the repulsive magnets 932A and 932B are radially and axially centered within the repulsive magnets 934A and 934B, respectively. The repulsive magnets 932A and 932B are fixed to the shaft 920. The repulsive magnets 934A and 934B are fixed to enclosure 904. For example, one or more of the repulsive magnets 932A, 932B, 934A, and 934B may be fixed using J-B Weld® product #8265-S or a similar, suitable adhesive.

In some embodiments, one or more of the repulsive magnets 932A, 932B, 934A, and 934B are comprised of rare earth grade 42. Additionally, in some embodiments, the repulsive magnets 932A and 932B may have inside diameters of about 0.500 inch, outer diameters of about 1.0 inch, and thicknesses (heights) of about 0.5 inches. The repulsive magnets 934A and 934B may have inside diameters of about 0.750 inches, outer diameters of about 1.5 inches, and thicknesses (heights) of about 0.250 inches.

In some embodiments, the passive radial magnetic bearings may include a different structure or orientation. For example, a Halbach magnet array, radially magnetized rings, or rings assembled using magnets shaped as segments of a desired assembled ring may be implemented in the flywheel assembly 900 of FIG. 9.

Wear elements 926A, 926B, 928A, 928B, 930A, and 930B fix the axial position of the flywheel rotor 902 and the shaft 920. For example, mechanical interaction of wear elements 926A, 928A, and 930A fix a first end of the shaft 920 and mechanical interaction of wear elements 926B, 928B, and 930B fix a second, opposite end of the shaft 920. Together, the wear elements 926A, 928A, 930A, 926B, 928B, and 930B act as axial or thrust bearings that constrain the axial position of the flywheel rotor 902 and the shaft 920.

The wear elements 926A, 926B, 928A, 928B, 930A, and 930B are manufactured from a wear resistant material. For example, the wear resistant material includes about 95% by volume diamond dust and about 5% metallic binder. Upon treatment with heat and pressure, the metallic binder consolidates the diamond dust into a hard, wear-resistant material that may subsequently be formed and polished to desired shape.

In some embodiments, the wear elements 926A and 926B are plane-parallel discs. The wear elements 926A and 926B may have a diameter of about 0.49 inches and a thickness of about 2.00 millimeters. Opposed faces of the wear elements 926A and 926B may be polished to an average roughness of less than 0.10 microns. One of the wear elements 926A and 926B may be mechanically fixed to each end of shaft 920 prior to rotation. For example, the wear elements 926A and 926B may be brazed to its corresponding position on shaft 920 using a titanium-activated braze. Prior to final assembly, the exposed surfaces of the wear elements 926A and 926B may be coated with a vacuum-compatible solid lubricant (e.g., Molykote® Z powder).

The wear elements 928A and 928B are spheres. The wear elements 928A and 928B may be comprised of Element Six type CTM302 PCD material. In some embodiments, the wear elements 928A and 928B may have radii of about 3.0 millimeters and an average surface roughness less than 0.10 microns. The wear elements 928A and 928B may be coated with a vacuum-compatible solid lubricant prior to assembly. The wear elements 928A and 928B run in or spin briefly in their locating depressions in the wear elements 930A and 930B prior to assembly.

The wear elements 930A and 930B are discs. The wear elements 930A and 930B may be comprised of Element Six type CTM302 PCD material. In some embodiments, the wear elements 930A and 930B may have a diameter of about 0.625 inches and a thickness of about 2 millimeters. One face of each of the wear elements 930A and 930B may be planar and polished to an average surface roughness of less than 0.10 microns. An opposite face of each of the wear elements 930A and 930B is similarly planar and polished to an average surface roughness of less than 0.10 microns.

A spherical depression is defined in the wear elements 930A and 930B. In some embodiments, the depth of the depression may be about 2.00 millimeters and the radius of the depression may be not less than about 3.00 millimeters. Each depression is centered on the face in which it is formed and may have an average surface roughness of less than about 0.10 microns.

The wear elements 930A and 930B are attached to their respective locations on the inner surface of enclosure 904 by adhesive bonding. For example, the wear elements 930A and 930B may be adhered to the enclosure 904 using J-B Weld® #8265-S adhesive or a similar product. Prior to assembly, each spherical depression may be coated with a vacuum-compatible solid lubricant. The wear elements 930A and 930B may be subjected to a brief run-in.

In some embodiments, the axial location and thrust bearing functionality of the flywheel assembly 900 may be obtained with other wear-resistant materials such as silicon carbide, tungsten carbide, synthetic diamond, other appropriate materials, or some combination thereof. As well, some embodiments include providing the axial location and thrust bearing functionality through use of other types of bearings, such as conical (tapered) roller bearings and thrust bearings comprised of planar surfaces separated by rolling elements.

Moreover, some embodiments use of interface or attachment materials that provide compliance and/or energy damping. The interface or attachment materials may be advantageous for a specific design with respect to rotor dynamics, stability, vibration control, or wear lifer. For example, wear elements 930A and 930B may be fixed to enclosure 904 using pads of compliant material placed between the wear elements and the enclosure surface. The pads of compliant material may provide compliance and/or energy dissipation. An example of using a compliant material is interposition of a layer of silicon rubber having a thickness of about 1/16 inches and a Durometer hardness of 50 A between each of the wear elements 930A and 930B and their corresponding locations on enclosure 904. A suitable elastomer material is silicone rubber. A suitable adhesive for bonding silicon rubber between the enclosure 904 and the wear elements 930A or 930B may include an adhesive tape (e.g., 3M™ Adhesive Transfer Tape type 7955MP).

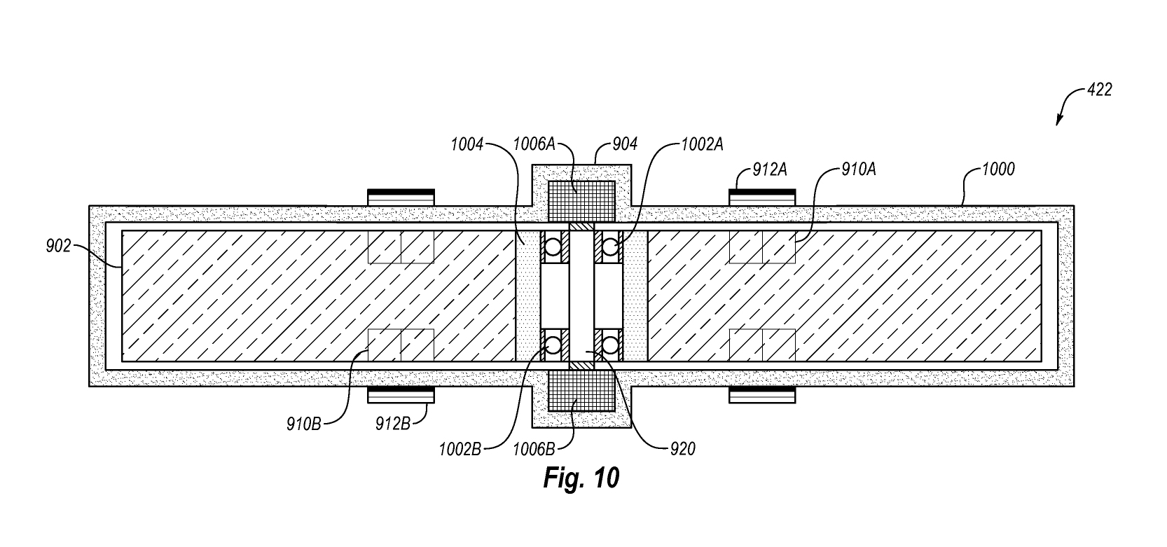

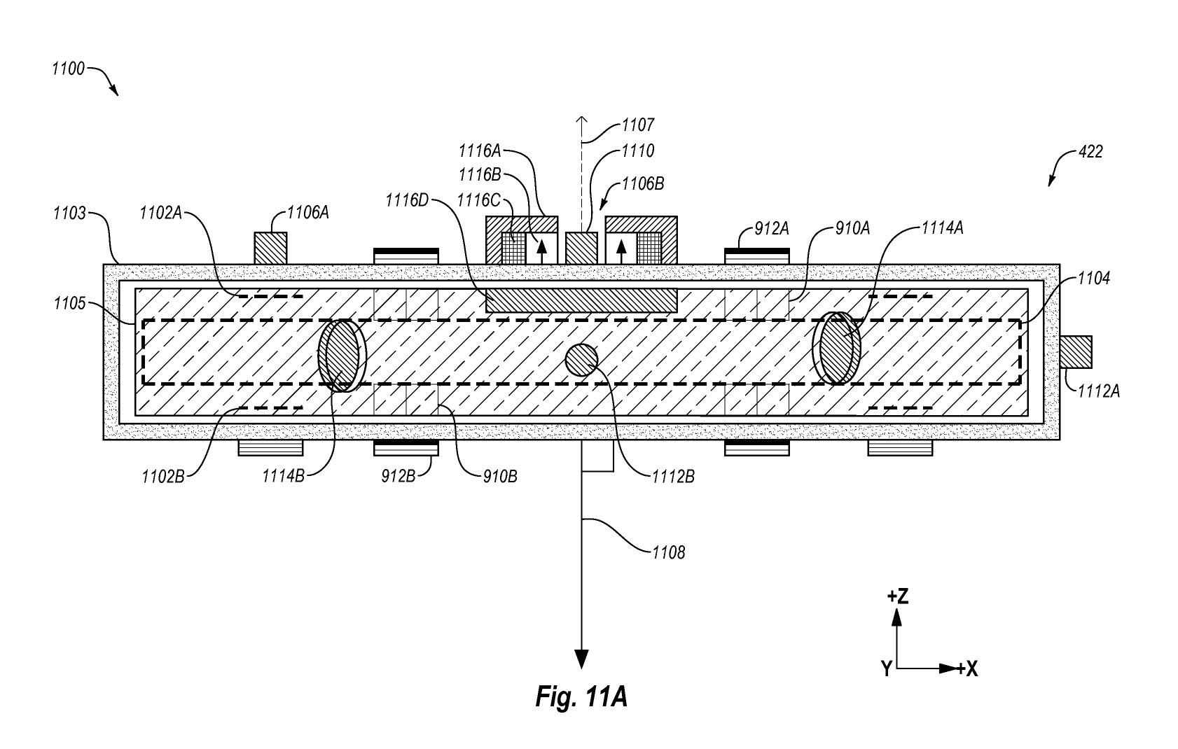

FIG. 10 illustrates an example embodiment of the storage device 422. In the embodiment of FIG. 10, the storage device 422 includes a flywheel assembly 1000. The flywheel assembly 1000 of FIG. 10 may be electrically coupled to a PV device string such as the PV device string 102 and to a PV output such as the PV output 106 described elsewhere in this disclosure. The flywheel assembly 1000 is configured to maintain and/or stabilize electrical output of a PV panel including the flywheel assembly 1000 as discussed elsewhere in this disclosure.

The flywheel assembly 1000 is similar to the flywheel assembly 900 described with reference to FIG. 9. For example, the flywheel assembly 1000 includes the flywheel rotor 902 that is connected to the shaft 920 and positioned in the enclosure 904. The enclosure 904 is evacuated. Energy storage and energy retrieval is accomplished using the arrays of magnets 910A and 910B and the electromagnetic coil assemblies 912A and 912B as described elsewhere in this disclosure. Some embodiments of the flywheel assembly 1000 may be sized similarly to the flywheel assembly 900 of FIG. 9 and may be comprised of similar materials.

The flywheel assembly 1000 includes roller element bearings 1002A and 1002B. The roller element bearings 1002A and 1002B provide mechanical support and spin isolation for the flywheel rotor 902. The roller element bearings 1002A and 1002B are positioned between the shaft 920 and a rotor bearing interface 1004. In some embodiments, the roller element bearings 1002A and 1002B may be attached to the shaft 920 or the rotor bearing interface 1004.

The rotor bearing interface 1004 provides a mechanical interface between the outer surfaces of roller element bearings 1002A and 1002B and the flywheel rotor 902. The rotor bearing interface 1004 may be comprised of materials such as elastomers that provide compliance and/or damping.

The flywheel assembly 1000 also includes capture components 1006A and 1006B. The capture components 1006A and 1006B provide a mechanical interface between shaft 920 and locations on the inner surface of the enclosure 904. The capture components 1006A and 1006B may be comprised of materials such as elastomers that provide compliance and/or damping.

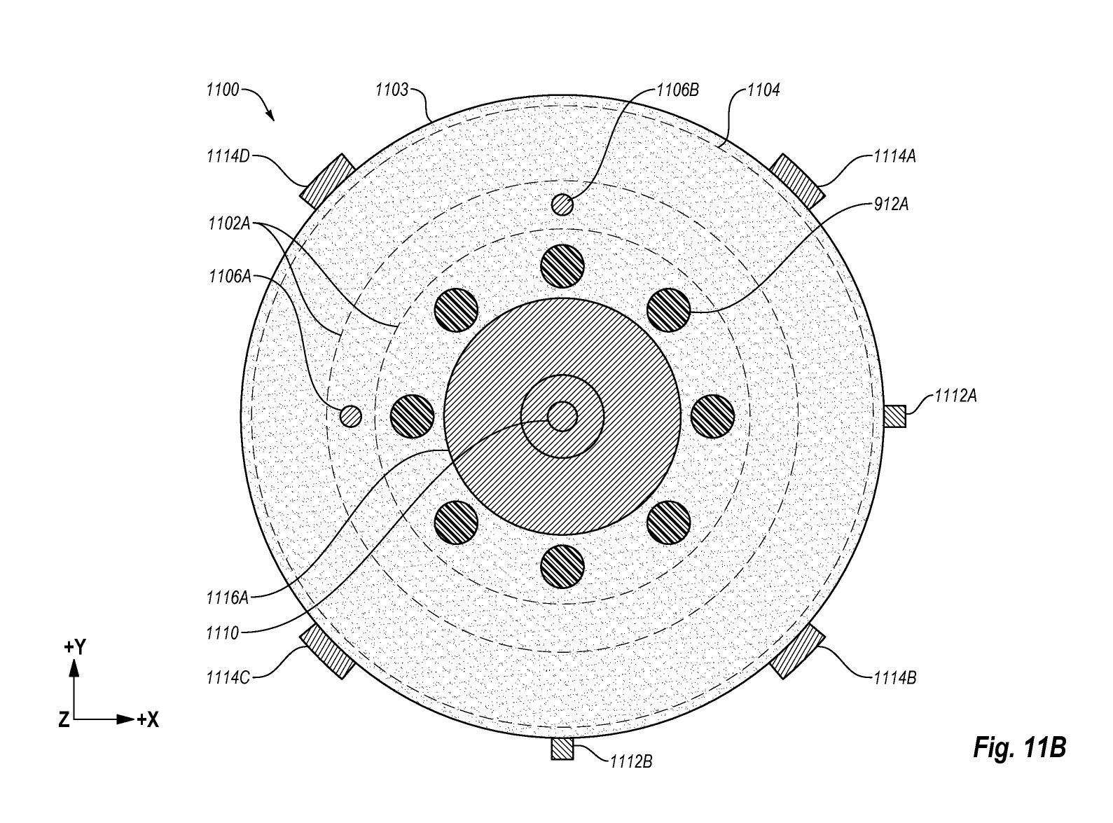

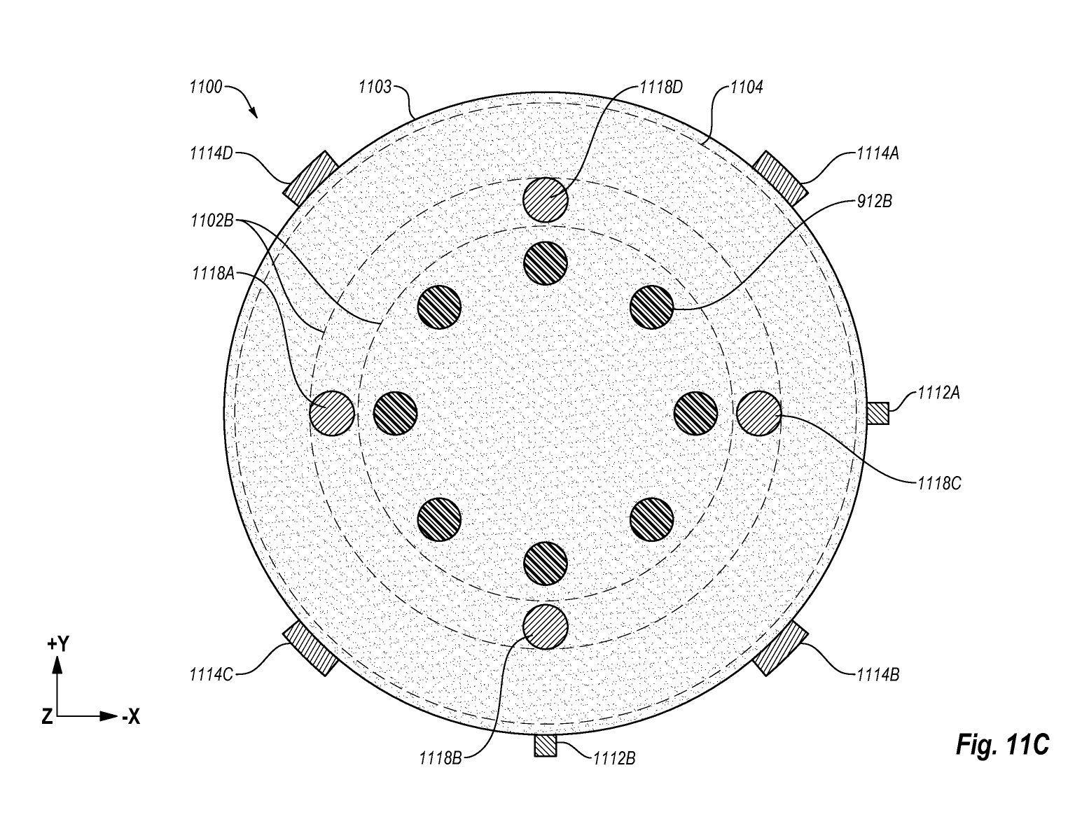

FIGS. 11A-11C illustrate a block diagram of another example embodiment of the storage device 422. The embodiment of FIGS. 11A-11C includes a flywheel assembly 1100. In particular, FIG. 11A depicts a sectional view of the flywheel assembly 1100. FIG. 11B depicts a top view of the flywheel assembly 1100. FIG. 11C depicts a bottom view of the flywheel assembly 1100.

The flywheel assembly 1100 of FIGS. 11A-11C may be electrically coupled to a PV device string such as the PV device string 102 and to a PV output such as the PV output 106 described elsewhere in this disclosure. The flywheel assembly 1100 is configured to maintain and/or stabilize electrical output of a PV panel including the flywheel assembly 1100 as discussed elsewhere in this disclosure. The flywheel assembly 1100 includes active magnetic rotor position control.

The flywheel assembly 1100 is a per-panel storage device that includes an enclosure 1103. The enclosure 1103 is similar to the enclosure 904 described above. For example, the enclosure 1103 is evacuated such that a vacuum or partial vacuum is formed within the enclosure 1103. The vacuum reduces resistance to rotation of a flywheel rotor 1105. The flywheel rotor 1105 is similar to the flywheel rotor 902 in material construction. The flywheel rotor 1105 is placed in the enclosure 1103. During operation, the flywheel rotor 1105 is positioned by electromagnetic actuators. Positioning the flywheel rotor 1105 reduces or eliminates wear incident to mechanical bearings.

Referring to FIG. 11A, the flywheel rotor 1105 rotates about a rotational axis 1107 that is parallel to an arbitrarily defined z-axis. During installation, the flywheel assembly 1100 is leveled substantially perpendicular with respect to local gravitational vector 1108. For example, the rotational axis 1107 may be substantially perpendicular to the x-axis of FIG. 11A. In some embodiments, the flywheel assembly 1100 may be leveled to within approximately 0.5° of perpendicular and in other embodiments to less than 0.1° of perpendicular. Leveling the flywheel assembly 1110 may be performed by adjustment of the mechanical structure (not shown) that supports enclosure 904.

Referring to FIGS. 11A-11C, the flywheel rotor 1105 may include ferromagnetic elements 1102A and 1102B. The ferromagnetic elements 1102A and 1102B may be incorporated within the flywheel rotor 1105 during its fabrication. The ferromagnetic elements 1102A and 1102B may be comprised of thin annular strips or rings of ferromagnetic material. For example, in the depicted flywheel assembly 1100, the ferromagnetic elements 1102A and 1102B may be constructed of 1018 alloy steel. Additionally in this and other embodiments, the ferromagnetic elements 1102A and 1102B may have a thickness of 0.010 inches, an inside diameter of 4.50 inches, and an outer diameter of 5.00 inches.

The ferromagnetic elements 1102A and 1102B may be adherently bonded to the depicted upper and lower planar surfaces, respectively, of the flywheel rotor 1105 after winding and finishing operations. Additionally or alternatively, the ferromagnetic elements 1102A and 1102B may be incorporated within the body of the flywheel rotor 1105 during winding operations. In embodiments in which the ferromagnetic elements 1102A and 1102B are incorporated within the body of the flywheel rotor 1105 they are embedded within the flywheel rotor 1105.

The flywheel rotor 1105 may also include a ferromagnetic element 1104. The ferromagnetic element 1104 may be incorporated within the flywheel rotor 1105 during its fabrication. The ferromagnetic element 1104 may be comprised of a strip of ferromagnetic material. For example, in the depicted flywheel assembly 1100, the ferromagnetic element 1104 includes a circumferential strip of 1018 alloy steel. In this and other embodiments, the ferromagnetic element 1104 may have a thickness of about 0.010 inches, a width (Z-axial extent) of about 0.5 inches, and an average radius of about 4.50 inches. The ferromagnetic element 1104 may be incorporated within the rotor structure during manufacture, which may result in the ferromagnetic element 1104 being embedded within the body of the flywheel rotor 1105. Additionally or alternatively, the ferromagnetic element 1104 may be adherently bonded to an outer cylindrical surface of the flywheel rotor 1105 after rotor winding and finishing operations.

As best depicted in FIG. 11B, the flywheel assembly 1100 also includes two ferromagnetic position sensors 1106A and 1106B. The ferromagnetic position sensors 1106A and 1106B are fixed to the upper outer surface of the enclosure 1103. The ferromagnetic position sensors 1106A and 1106B may include inductive-proximity sensors (e.g., Eaton Cutler Hammer Inductive Proximity Sensor E57).

Referring back to FIGS. 11A-11C, the flywheel assembly 1100 includes sensors 1110, 1106A, 1106B, 1112A, and 1112B. The sensors 1110, 1106A, 1106B, 1112A, and 1112B provide data that enable computation of the position of the flywheel rotor 1105 with respect to the enclosure 1103. The position of the flywheel rotor 1105 with respect to enclosure 1103 is used to maintain physical clearance between the flywheel rotor 1105 and the enclosure 1103 during operation. For example, when data measured by the sensors 1110, 1106A, 1106B, 1112A, and 1112B indicate the flywheel rotor 1105 may hit the enclosure 1103, a corrective signal is generated that re-position the flywheel rotor 1105 relative to the enclosure 1103.

The flywheel assembly 1100 includes the ferromagnetic position sensors 1106A and 1106B that are positioned opposite the ferromagnetic element 1102A. For example, a first ferromagnetic position sensor 1106A is positioned on an axis that is parallel to the x-axis and a second ferromagnetic position sensor 1106B is positioned on an axis that is parallel to the y-axis. Each of the ferromagnetic position sensors 1106A and 1106B provides data for computation of distance between it and the ferromagnetic element 1102A. Because the ferromagnetic position sensors 1106A and 1106B are disposed at 90° angles about a circumference, data from the sensors 1106A and 1106B yields data about a position of the flywheel rotor 1105 relative to the an axis parallel the z-axis.

The flywheel rotor 1105 includes a levitator susceptor 1116D. The levitator susceptor 1116D may be incorporated in the flywheel rotor 1105. The flywheel assembly 1100 also includes a ferromagnetic sensor 1110. The ferromagnetic sensor 1110 is positioned in the center of the enclosure 1103 and opposite the levitator susceptor 1116D. The ferromagnetic sensor 1110 measures a distance between itself and the levitator susceptor 1116D and communicates data representative of the distance.

Combined data from the ferromagnetic sensors 1110 and 1106A may be processed to determine tilt of the flywheel rotor 1105 about the y-axis with respect to gravitational vector 1108. Combined data from the ferromagnetic sensors 1110 and 1106B similarly yield tilt of the flywheel rotor 1105 about the x-axis. Combined data from the ferromagnetic sensors 1110, 1106B, and 1106A allow computation of the flywheel rotor 1105 position on an axis parallel to the z-axis.

The flywheel assembly 1100 includes sensors 1112A and 1112B. The sensors 1112A and 1112B are fixed to the outer circumferential surface of enclosure 1103. The sensors 1112A and 1112B measure distance from each sensor to a ferromagnetic element 1104. Data from the sensors 1112A and 1112B may be processed to determine radial positions of the flywheel rotor 1105.

In the depicted embodiment position sensors are used with magnetic sensors and ferrite targets. In some embodiments, distances between the flywheel rotor 1105 and the enclosure 1103 may be measured using other types of sensors such as optical or capacitive sensors.

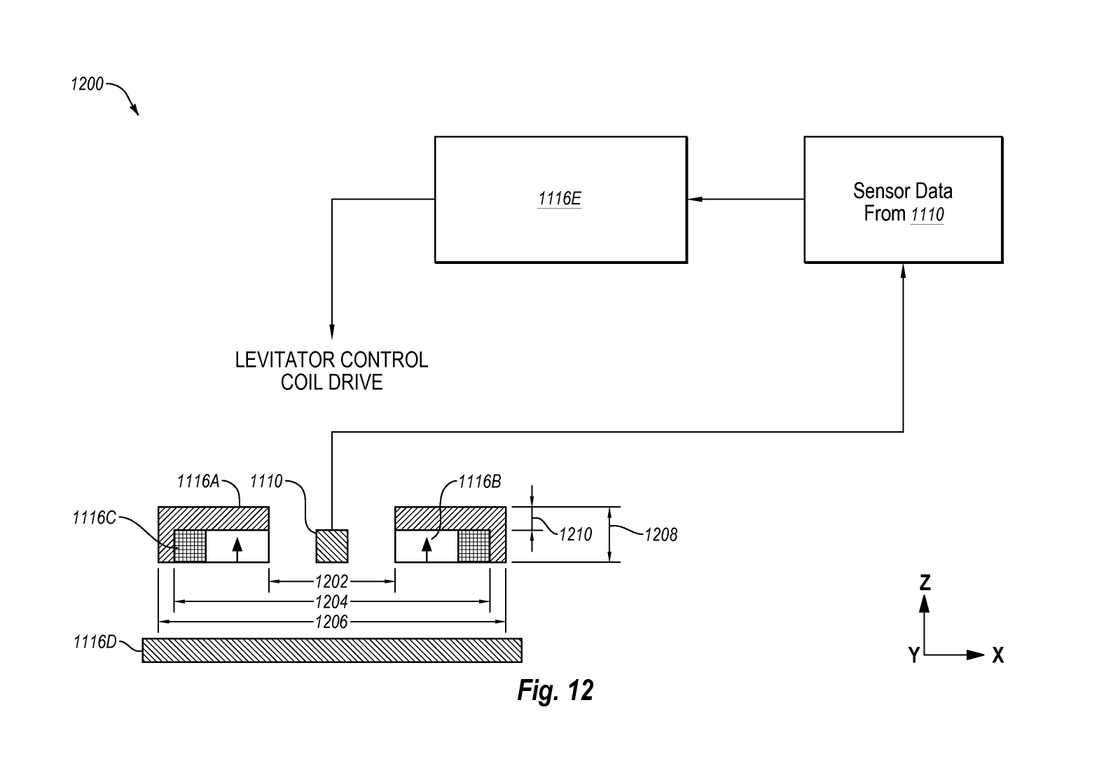

FIG. 12 illustrates an example levitator assembly 1200 that may be implemented with the flywheel assembly 1100 of FIGS. 11A-11C. FIG. 12 depicts a portion of the flywheel assembly 1100 of FIG. 11 with the flywheel rotor 1105 and the enclosure 1103 omitted.

The levitator assembly 1200 includes a levitator pole 1116A. The levitator pole 1116A may be fabricated from 1018 alloy steel or a material having similar mechanical and ferromagnetic properties. In the depicted embodiment, the levitator pole 1116A has a first inner diameter 1202 of about 1.0 inch, a second inner diameter 1204 of about 2.50 inches, and an overall outer diameter 1206 of about 2.75 inches. The levitator pole 1116A has a first thickness 1210 (in the z-direction) of about 0.1875 inches and a second thickness 1208 of about 0.4375 inches.

Fixed to the levitator pole 1116A is a levitator magnet 1116B. The levitator magnet 1116B is a rare earth ring magnet. The magnetic properties of the levitator magnet 1116B may be those of rare earth magnet grade 42. In the depicted embodiment, the levitator magnet 1116B has its magnetization direction oriented axially as depicted by the arrow shown on the levitator magnet 1116B. The arrowhead indicating magnetic North. By reason of its high relative magnetic permeability, the levitator pole 1116A provides a confining path for magnetic flux provided by the levitator magnet 1116B.

The levitator assembly 1200 includes a levitator control coil 1116C. The levitator control coil 1116C may include about 85 turns of #26 insulated copper magnet wire helically wound in some embodiments. The levitator control coil 1116C is positioned in the annulus formed between the outer diameter of the levitator magnet 1116B and the opposed cylindrical surface of the levitator pole 1116A. The levitator control coil 1116C may be fixed in place using an epoxy adhesive. The levitator control coil 1116C is connected to and may be controllably energized by levitator control electronics 1116E. Energizing the levitator control coil 1116C may include an electrical current of about 15 Amperes in magnitude and either polarity being initiated by the levitator control electronics 1116E which may flow through the levitator control coil 1116C.

The levitator susceptor 1116D is a disc made from a ferromagnetic material. For example, the levitator susceptor 1116D may be comprised of steel alloy 1018 or a dispersion of ferromagnetic particles within a matrix material such as a plastic or other substantially non-ferromagnetic material. The levitator susceptor 1116D is subject to an attractive force generated when positioned in proximity to a magnetic field. For example, a controllable field presented by the levitator pole 1116A, the levitator magnet 1116B, and levitator control coil 1116C as controllably energized by the levitator control electronics 1116E may subject the levitator susceptor 1116D to an attractive force.

In the depicted embodiment, the levitator susceptor 1116D has an outer diameter of about 3.0 inches and a thickness of about 0.25 inches. As mentioned above, the ferromagnetic sensor 1110 is a position sensor that measures distances between itself and the levitator susceptor 1116D. Data representative of the distances are supplied to the levitator control electronics 1116E.

The electromagnetic field caused by passage of electric current through levitator control coil 1116C controllably varies magnetic flux within the levitator pole 1116A. The effect of the magnetic flux controllably changes the attractive force exerted on the levitator susceptor 1116D. The attractive force can be increased or decreased depending on the magnitude and polarity of electric current driven through the levitator control coil 1116C. Thus, the operation of the levitator assembly 1200 positions or re-positions the flywheel rotor 1105 relative to the enclosure 1103. Positioning or re-positioning the flywheel rotor 1105 relative to the enclosure 1103 assures no mechanical contact occurs between the flywheel rotor 1105 and the enclosure 1103 during operation.

On energizing the levitator assembly 1200, the levitator control electronics 1116E with rotor axial position data from the ferromagnetic sensor 1110 energizes the levitator control coil 1116C to set the magnitude of attractive force exerted on the levitation susceptor 1116D. The levitator control coil 1116C lifts flywheel rotor 1105 of FIGS. 11A-11C and its affixed components away from physical contact with enclosure 1103. The levitator control electronics 1116E further refine the axial levitated position of the flywheel rotor 1105 to minimize the electrical current sent by the levitator control coil 1116C to levitate the flywheel rotor 1105. The current may be minimized by relying at least partially on the permanent ring magnet 1116B, which involves no energy supply for its force.

In some embodiments, the levitator control electronics 1116E are programmed to position the flywheel rotor 1105 on an axis parallel to the z-axis such that the attractive force developed by levitator magnet 1116B as resolved on levitator susceptor 1116D is essentially equal to the force exerted by gravity on the flywheel rotor 1105.

Referring back to FIGS. 11A-11C, the flywheel assembly 1100 includes electromagnetic actuator elements 1114A, 1114B, 1114C, and 1114D. The actuator elements 1114A, 1114B, 1114C, and 1114D may include coils of magnet wire that may be controllably energized to produce forces that attract the ferromagnetic element 1104, which is fixed to the flywheel rotor 1105. Energizing the actuator elements 1114A, 1114B, 1114C, and 1114D cause radial translation of flywheel rotor 1105 relative to the enclosure 1103. Magnitude and direction of rotor translation is determined by the magnitude of electrical current applied to one or more of the actuator elements 1114A, 1114B, 1114C, and 1114D. For example, translation in the positive y-direction may be achieved by energizing the actuators 1114A and 1114D substantially equally, which may create two attractive force vectors of substantially equal magnitude and substantially equal but opposite projections along an axis parallel to the X-axis. The two attractive force vectors resolve to a single force vector pulling the flywheel rotor 1105 in substantially the positive y-direction.

Referring to FIG. 11C, the flywheel assembly 1100 includes electromagnetic actuator elements 1118A, 1118B, 1118C, and 1118D. The electromagnetic actuator elements 1118A, 1118B, 1118C, and 1118D together controllably exert attractive force on the flywheel rotor 1105 that can controllably tilt the flywheel rotor 1105. For example, the electromagnetic actuator elements 1118A, 1118B, 1118C, and 1118D cause the flywheel rotor 1105 to pivot about axes parallel to the x-axis or y-axis through interaction with the ferromagnetic element 1102B. Control of rotating bodies that the computation of flywheel rotor 1105 tilt corrections, which is referenced above, incorporate and compensate for precession effects that are functions of rotor mass distribution and spin rate.

The electromagnetic actuator elements 1118A-1118D and 1114A-1114D may include a coil having about 50 turns of #26 magnet wire. The average diameters of the coils may be about 0.5 inches. The coils may be fixed opposite to their respective proximate ferromagnetic elements at angular positions approximately equidistant between the sensors 1106A and 1106B. The electromagnetic actuator elements 1118A-1118D and 1114A-1114D are controllably energized by rotor position control computation (not depicted), which may include signal conditioning electronics, computation, and power drive electronics. The power drive electronics may be connected to the electromagnetic actuator elements 1118A-1118D and 1114A-1114D.

In some embodiments, different means of actuator construction, such as printed conductors on circuit boards, may be employed without departing from the scope of this disclosure. Moreover, different types of actuators, such as those which operate through generation of Lorentz forces rather than through attraction of ferromagnetic materials, are contemplated in this disclosure.

With combined reference to FIGS. 11A-12, the sensors 1110, 1106A, 1106B, 1112A, 1112B, the levitator components 1116A-1116E, the actuators 1114A-1114D, and actuators 1118A-1118D together with computational means (not shown) effect positional control of the flywheel rotor 1105 in 5 degrees of freedom (x-direction, y-direction, z-direction, rotation about an axis parallel to the X-axis, and rotation about Y an axis parallel to the y-axis).

The flywheel assembly 1100 further includes the arrays of magnets 910A and 910B and the electromagnetic coil assemblies 912A and 912B described with reference to FIG. 9. The arrays of magnets 910A and 910B and the electromagnetic coil assemblies 912A and 912B effect control of the spin of the flywheel rotor 1105 about the rotational axis 1107. In addition, the arrays of magnets 910A and 910B and the electromagnetic coil assemblies 912A and 912B operate to store and retrieve energy from the flywheel rotor 1105 as described elsewhere in this disclosure.

During spin operations, position control electronics maintain the position of flywheel rotor 1105 within a defined spatial envelope. Positioning or re-positioning the flywheel rotor 1105 occurs in response to the flywheel rotor 1105 exiting the defined envelope or in response to a prediction that the flywheel rotor 1105 is going to exit the defined envelop. The data representative of the position of the flywheel rotor 1105 is used in computations to make determinations regarding a current position of the flywheel rotor 1105. The flywheel rotor 1105 is otherwise not subjected to correction.

During operation, the flywheel rotor 1105 is first positioned for spin by moving it away from contact with enclosure 1103. The arrays of magnets 910A and 910B and the electromagnetic coil assemblies 912A and 912B are then energized to spin the flywheel rotor 1105. In the depicted embodiment, the flywheel rotor 1105 may be accelerated to a maximum of about 110,000 RPM by electricity produced by a PV device string (e.g., 102) at which point the flywheel assembly 1100 holds approximately 100 Watt-hours of kinetic energy. However, some embodiments may limit operation to about 73% of this maximum at which the flywheel assembly may hold about 80 Watt-hours. The stored energy may be retrieved as described elsewhere in this disclosure to maintain electrical output of a PV panel.

In some embodiments, the flywheel assembly 1100 may be configured as described in U.S. patent application Ser. Nos. 13/280,232 and 13/280,314 filed Oct. 24, 2011, the disclosures of which are incorporated herein by reference in their entireties.

Some embodiments described in this disclosure are related to a PV panel. The PV panel is configured as a modular electrical source with per-panel energy storage. Energy storage is added to a PV electrical source, such as those assemblies of PV devices commonly known as solar panels. Energy storage is provided on a per-panel basis, i.e., energy produced by a single PV panel is stored within a storage device located on that panel. When electrical output of the PV panel is reduced, the storage device delivers energy stored thereon to the panel's electrical load. Such per-panel energy storage continues a panel's nominal electrical output if insolation of the PV panel is interrupted or diminished, thereby eliminating or reducing rapid output variations and electrical distribution grid instabilities associated with solar photovoltaic electrical sources.

What is claimed is:

1. A solar photovoltaic (PV) panel configured as a modular electrical source, the PV panel comprising:
an electrical PV output that is configured to be electrically coupled to a distribution system such that electricity produced by the PV panel is supplied to the distribution system;
a storage and retrieval subsystem that includes a dedicated energy storage device, wherein the storage and retrieval subsystem is electrically coupled to the PV output and configured to provide per-panel energy storage to the PV panel; and
one or more PV cells that are electrically coupled to the PV output and electrically coupled to the dedicated energy storage device, wherein the PV cells are configured to photovoltaically generate an electrical potential in response to exposure to incident illumination, and during periods in which incident illumination is available to the PV cells, to supply a first portion of the electrical potential to the PV output and a second portion of the electrical potential to the dedicated energy storage device,
wherein the storage and retrieval subsystem is further configured to intermediately supply energy stored thereon to the PV output during periods in which incident illumination is unavailable or partially unavailable to the PV cells.

2. The PV panel of claim 1, wherein the dedicated energy storage device is configured such that energy supplied to the PV output by the dedicated energy storage device maintains a nominal electrical output of the PV panel for a particular period of time following an onset of unavailability or partial unavailability of the incident illumination.

3. The PV panel of claim 2, wherein the particular period of time is about 10 minutes following the onset of the unavailability or partial unavailability.

4. The PV panel of claim 2, wherein the nominal electrical output includes:
an unregulated direct current (DC) voltage and DC current,
regulated counterparts of the unregulated DC voltage and DC current,
an alternating current (AC) of a particular voltage, a particular frequency, and a particular reactive power content, or
an AC of a controllable voltage, a controllable frequency, and a controllable reactive power content.

5. The PV panel of claim 1, wherein the incident illumination is unavailable or partially unavailable to the photovoltaic cells when the electrical output of the panel is decreased by more than about 10% of a nominal electrical output.

6. The PV panel of claim 1, further comprising a frame, wherein the storage and retrieval subsystem is mechanically attached to the frame or the storage and retrieval subsystem is physically incorporated within the frame.

7. The PV panel of claim 1, wherein the storage and retrieval subsystem includes a bi-directional inverter that is configured to receive electrical energy from the distribution system during periods in which energy production in the distribution system exceeds a load in the distribution system and to store the received electrical energy in the dedicated energy storage device.

8. The PV panel of claim 1, wherein the dedicated energy storage device includes one or more or a combination of a flywheel assembly, an electrochemical storage device, and a pneumatic storage system.

9. A multi-panel generation system comprising one or more of the PV panels of claim 1.

10. The PV panel of claim 1, wherein the dedicated energy storage device is configured such that energy supplied to the PV output by the dedicated energy storage device exceeds a nominal electrical output of the PV panel.

11. A storage and retrieval subsystem of a solar photovoltaic (PV) panel, the storage and retrieval subsystem comprising:
a dedicated energy storage device that is electrically coupled to a PV output of the PV panel and to a PV device string that produces electricity in response to exposure to insolation,
wherein:
the dedicated energy storage device is configured to receive and store a portion of the electricity produced by the PV device string and to intermediately supply the stored energy to the PV output in response to an indication that the insolation is unavailable or partially unavailable, and
the dedicated energy storage device provides per-panel energy storage to the PV panel.

12. The storage and retrieval subsystem of claim 11, further comprising an inverter that is electrically coupled to the dedicated energy storage device, wherein the inverter is configured to draw energy from the dedicated energy storage device and convert the energy from a direct current (DC) electrical potential to an alternating current (AC) electrical output and supply the AC electrical output to the PV output.

13. The storage and retrieval subsystem of claim 12, further comprising a controller that is electrically coupled to the inverter, wherein the controller is configured to control the inverter according to a programmed allocation of energy between the dedicated energy storage device and the PV output and according to a defined PV panel behavior.

14. The storage and retrieval subsystem of claim 13, further comprising:
a maximum power point transfer (MPPT) device electrically coupled between the controller and the PV device string, the MPPT device configured to determine an optimal current-voltage (IV) point based on environmental conditions of the PV panel; and
a communication unit that is electrically coupled to the controller and configured to communicate status information of the dedicated energy storage device.

15. The storage and retrieval subsystem of claim 11, further comprising battery management electronics that include an isolation diode, wherein:
the dedicated energy storage device includes an electrochemical storage device, and
the electrochemical storage device supplies energy to the PV output in response to electrical output at the PV output dropping below a voltage of the electrochemical storage device.

16. The storage and retrieval subsystem of claim 11, wherein the dedicated energy storage device includes a flywheel assembly.

17. The storage and retrieval subsystem of claim 16, wherein the flywheel assembly includes an active magnetic rotor position control.

18. A solar photovoltaic (PV) panel configured as a modular electrical source, the PV panel comprising:
an electrical PV output that is configured to be electrically coupled to a distribution system such that electricity is transferable between the PV panel and distribution system;
a storage and retrieval subsystem that is electrically coupled to the PV output and configured to provide per-panel energy storage and to intermediately supply energy stored thereon to the PV output; and
a PV device string that is electrically coupled to the PV output and to a storage and retrieval subsystem,
wherein:
during periods in which insolation is available to the PV device string an electrical potential is photovoltaically produced, a first portion of which is supplied to the PV output and a second portion of the electrical potential is supplied to the storage and retrieval subsystem, and
during periods in which energy production in the distribution system exceeds a load in the distribution system, a portion of energy produced in the distribution system is stored in the dedicated energy storage device.

19. The PV panel of claim 18, wherein: during periods in which insolation is unavailable or partially unavailable, some portion of energy stored on the storage and retrieval subsystem is supplied to the PV output.

20. The PV panel of claim 18, wherein the storage and retrieval subsystem includes:
a flywheel assembly having active magnetic rotor position control;
a bi-directional inverter that is electrically coupled to the flywheel assembly, wherein the bi-directional inverter is configured to draw energy from the flywheel assembly and supply an electrical output to the PV output and to receive electrical energy from the distribution system and supply the electrical energy to the flywheel assembly;
a controller that is electrically coupled to the bi-directional inverter, wherein the controller is configured to control the bi-directional inverter according to a programmed allocation of energy between the flywheel assembly and the PV output and according to a defined PV panel behavior;
a maximum power point transfer (MPPT) device that is electrically coupled between the controller and the PV device string, the MPPT device configured to determine an optimal current-voltage (IV) point based on environmental conditions of the PV panel; and
a communication unit that is electrically coupled to the controller and configured to communicate status information of the flywheel assembly.

21. The PV panel of claim 20, wherein the flywheel assembly includes:
an enclosure that is evacuated;
a flywheel rotor positioned within the enclosure; and
levitator control electronics that are configured to re-position the flywheel rotor within the enclosure in response to the flywheel rotor exiting a spatial envelope defined in the enclosure.

22. The PV panel of claim 21, wherein the flywheel assembly is configured to store about 100 Watt-hours of kinetic energy.
